(19) United States
(12) Patent Application Publication
(10) Pub. No.: US 2014/0195675 A1
(43) Pub. Date: Jul. 10, 2014

(54) Simultaneous Content Data Streaming And Interaction System

(71) Applicant: Giga Entertainment Media Inc., Walnut Creek, CA (US)

(72) Inventor: Lawrence Way Silver, Walnut Creek, CA (US)

(73) Assignee: Giga Entertainment Media Inc., Walnut Creek, CA (US)

(21) Appl. No.: 14/150,009

(22) Filed: Jan. 8, 2014

Related U.S. Application Data
(60) Provisional application No. 61/750,387, filed on Jan. 9, 2013.

(51) Int. Cl. H04L 29/06

(52) U.S. Cl. CPC H04L 65/1083
USPC 709/224; 709/231

(57) ABSTRACT

A computer implemented method and system simultaneously distributes content data streams (CDSs) of multiple content formats, for example, live cable television content, gaming content, social media content, user generated content, etc., to one or more computing devices. An interactive content distribution platform (ICDP) receives user selections of the CDSs and the content formats via a graphical user interface (GUI) and receives one or more CDSs in one or more content formats from multiple content sources based on the user selections. The ICDP synchronizes the CDSs by encoding the CDSs into a common data format and adjusting a transmission rate of the CDSs. The ICDP simultaneously transmits and displays the synchronized CDSs in one or more configurable windows on a display screen of each computing device at configurable time instances via the GUI. The ICDP facilitates interactions and initiates transactions between computing devices during the simultaneous display of the synchronized CDSs.

### CROSS REFERENCE TO RELATED APPLICATIONS

This application claims priority to and the benefit of provisional patent application No. 61/750,387 titled “Simultaneous Content Data Streaming And Interaction System”, filed in the United States Patent and Trademark Office on Jan. 9, 2013. The specification of the above referenced patent application is incorporated herein by reference in its entirety.

### BACKGROUND

The computer implemented method and system disclosed herein, in general, relates to providing interactivity over a network. More particularly, the computer implemented method and system disclosed herein relates to providing multiple content data streams simultaneously in at least one of a common format, a digital wrapper, or a container format, where transmission rates and client capacity are monitored to maintain a continuous presentation of each of the content data streams, without requiring buffering.

Recent trends show that the amount of time people spend trying to multitask on their computing devices, for example, tablets, computers, laptops, smart phones, etc., while watching television (TV) is increasing sharply. There is a need to find a solution to this requirement for users who utilize multiple computing devices, whether in their hands, or on their laps at all times, for today's digital device addiction, and to meet the needs and demands of the technically sound and the technology demanding generation to simplify the process of digital multitasking. Television has not kept pace with day-to-day digital related innovations. On a computer, a user can multitask, for example, access a voice over internet protocol (VoIP) and messaging service such as Skype® of Skype Corporation, send electronic mails (emails), watch a video, etc., but a TV just beams out at the user. About 57% of the users of computing devices try to get around this deficiency unsuccessfully by using a second or third screened computing device. Accordingly, there is a need for a computer implemented method and system that provides a user friendly platform which combines the most used media features simultaneously on one site. Since the inception of satellite TV, cable rates have increased over 125%, proving that the cable industry prefers to lose market share by approximately 30% and raise rates sharply to compensate for the lost revenue to new competitors in the media delivery industry. This has been primarily driven by huge debt loads cable companies incurred in order to install expensive fiber-optic infrastructure.

Recent studies showed that multitasking makes a person less productive, yet that has not stopped a majority of smart phone users from juggling multiple electronic devices. About 80% of people multitask on their mobile devices while watching TV. Using a laptop, especially an internet enabled device, in front of the TV as commercials are aired is not a new behavior. With the advent of the digital video recorder (DVR) over a decade ago, viewers are able to fast forward through an advertisement, due to which advertisers may go out of business. Recently, with an increased usage of tablets and smart phones, consumers are more engaged and distracted. However, there are a few newly introduced mobile applications and mobile tools, for example, Shazam® of Shazam Entertainment Limited, that offer a solution for marketers to encourage viewers to take notice of and interact with their advertisements.

According to a survey conducted by Yahoo!® Mobile in partnership with Razorfish LLC that polled about 2,000 adults in the United States (U.S.) on their mobile habits and device preferences, to help marketers better understand consumer behavior, 38% of the respondents were of the opinion that internet browsing enhances their TV viewing experience. On the other hand, another 38% stated that web browsing while watching TV is distracting. As per the survey results, 70% of the respondents multitask at least once a week, while 49% of the respondents multitask daily. A staggering 15% of the respondents are engaged on their phones for an entire duration of a program that is aired on the TV. According to the survey, the top 5 program genres that attract human multitasking are reality shows, news, comedy, sports, and food. 94% of the respondents engage in some form of mobile communication while watching TV, for example, exchanging email, sending instant messages (IMs), texting, talking or social networking, etc. 60% of the respondents browse the internet on their mobile devices, of which 44% search for unrelated content and 38% search for related content. There is a need for a computer implemented method and system that allows service providers to provide their customers with a multitasking platform that enables marketers to provide their content to customers with monetization of the content marketed by them, primarily driven by subscription fees, pay-per-view (PPV), video on demand (VOD), advertising, demographic targeting, etc.

There is considerable interest today for methods to integrate supplemental content information with broadcast media. For example, broadcasters seek ways to engage viewers by providing interactive content from a disparate content source, for example, the internet, that coincides with or supplements a program being broadcast. However, current interaction with the internet is quite limited today, because a typical TV viewer does not have a personal computer conveniently located in a TV viewing room, nor is the typical TV viewer able to navigate to appropriate internet addresses while watching a TV program on the same display screen. Moreover, current interaction approaches cannot synchronize supplemental internet content with broadcast program content if the broadcast program content is delayed, for example, through recording or time shifting.

Prior systems have employed an internet protocol television (IPTV) service as an alternative method for providing live TV programs to subscribers. In IPTV, TV programs may be transmitted on top of an IP based multicast. Similar to traditional forms of broadcast TV, for each TV channel, there is only one set of video content streams being broadcasted through the IPTV network. Also, similar to cable and satellite TV delivery systems, the pricing for IPTV services is typically related to the number of channels and video quality of the TV programs, for example, standard, digital or high definition (HD) TV programs.

Hence, there is a long felt but unresolved need for a computer implemented method and system that simultaneously distributes multiple content data streams of multiple content formats to one or more computing devices. Moreover, there is a need for a computer implemented method and system that provides interactivity over a network. Moreover, there is a need for a computer implemented method and system that provides multiple content data streams simultaneously in at least one of a common format, a digital wrapper, or a container format, where transmission rates and client capacity are monitored to maintain a continuous presentation of each of the content data streams, without requiring buffering. Furthermore, there is a need for a computer implemented method and system that provides control over the delivery of the content data streams simultaneously, where the simultaneous content data streaming includes an integration of, for example, live high definition (HD) streaming, live cable including live video content, movies, simultaneous multiple picture-in-picture, expandable, shrinking, moving or floating screens on one site, which further includes, for example, simultaneous live personal or group chatting and video conferencing, texting, electronic mailing, blogging, social networking through social media, video gaming, web surfing, video-on-demand, home automation, augmented reality, voice recognition, analytical history of content viewing, digital video recorder (DVR) functionality, digital marketing, sharing of data, etc., simultaneously. Moreover, there is a need for a computer implemented method and system that provides a uniform presentation of content from a variety of different sources and formats, where multiple audio, video and data sources can be combined in a single player, without requiring additional downloads or software installation by a client computing device. Furthermore, there is a need for a computer implemented method and system that allows integration of a secondary content data stream simultaneously with a primary content data stream, in response to predetermined synchronization, user initiated synchronization, or data associated with the primary content data stream simultaneously.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for simultaneously distributing multiple content data streams of multiple content formats to one or more computing devices. The computer implemented method and system disclosed herein provides interactivity over a network. Moreover, the computer implemented method and system disclosed herein provides multiple content data streams simultaneously in at least one of a common format, a digital wrapper, or a container format, where transmission rates and client capacity are monitored to maintain a continuous presentation of each of the content data streams, without requiring buffering. The computer implemented method and system disclosed herein provides control over the delivery of the content data streams simultaneously, where the simultaneous content data streaming includes an integration of, for example, live high definition (HD) streaming, live cable including live video content, movies, simultaneous multiple picture-in-picture, expandable, shrinking, moving or floating screens on one site, which further includes, for example, simultaneous live personal or group chatting and video conferencing, texting, electronic mailing, blogging, social networking through social media, video gaming, web surfing, video-on-demand, home automation, augmented reality, voice recognition, analytical history of content viewing, digital video recorder (DVR) functionality, digital marketing, sharing of data, etc., simultaneously. Moreover, the computer implemented method and system disclosed herein provides a uniform presentation of content from a variety of different sources and formats, where multiple audio, video and data sources can be combined in a single player, without requiring additional downloads or software installation by a client computing device. Furthermore, the computer implemented method and system disclosed herein allows integration of a secondary content data stream simultaneously with a primary content data stream, in response to a predetermined synchronization, user initiated synchronization, or data associated with the primary content data stream simultaneously.

The computer implemented method and system disclosed herein provides an interactive content distribution platform comprising at least one processor configured to simultaneously distribute the content data streams of different content formats to one or more computing devices in real time. The interactive content distribution platform is configured to provide a graphical user interface (GUI) accessible by each of the computing devices via a network. The interactive content distribution platform receives user selections of content data streams and content formats via the GUI. The content data streams comprise, for example, live cable television (TV) content, live high definition streaming content, multimedia chat content, live multimedia chat content, video conferencing content, gaming content, web browsing content, video-on-demand content, home automation content, voice recognition content, augmented reality content, social media networking content, live video content, canned video content, digital video recorder video content, user generated content, message content, electronic mail content, audio content, three-dimensional media content, electronic commerce content, information, blog content, analytical information of viewed content, multimedia content, etc., and any combination thereof. The interactive content distribution platform receives the user selections through one or more of multiple communication modes comprising, for example, a voice mode, a video mode, a text mode, a multimedia mode, a telephonic mode, etc., and any combination thereof.

The interactive content distribution platform receives one or more of the content data streams in one or more of the content formats from multiple content sources based on the received user selections. The interactive content distribution platform comprises one or more databases for storing one or more of the content data streams of different content formats, information associated with the content data streams, information associated with the content sources, information associated with multiple users, etc. The databases are accessible by the users and/or the content sources via the network. The interactive content distribution platform synchronizes the received content data streams by encoding the received content data streams into a common data format and adjusting a transmission rate of the received content data streams. The interactive content distribution platform simultaneously transmits and displays the synchronized content data streams in one or more configurable windows on a display screen of each of the computing devices at configurable time instances via the GUI. As used herein, the phrase “time instances” refers to instances of time configured by the interactive content distribution platform or configured based on user preferences for simultaneously transmitting and displaying content data streams. The time instances are, for example, one at a time or all at the same time. The synchronized content data streams in each of the configurable windows are changeable based on the received user selections. In an embodiment, each of the received content data streams is accessible via a link and is configured to serve as a gateway to one or more other content data streams.

The interactive content distribution platform facilitates interactions and initiates transactions between the computing devices during the simultaneous display of the synchronized content data streams in one or more configurable windows on the display screen of each of the computing devices via the GUI. For example, the interactive content distribution platform automatically transmits and displays one or more notifications and content in one or more configurable windows on the display screen of each of the other computing devices of one or more users who are viewing the synchronized content data streams on the other computing devices via the GUI. In another example, the interactive content distribution platform automatically transmits and displays one or more advertisements being viewed by one of multiple users to one or more configurable windows on the display screen of each of the other users who are viewing the synchronized content data streams on the other computing devices via the GUI.

In an embodiment, the interactive content distribution platform configures one or more digital media parameters for incorporating one or more media effects in the displayed content data streams in one or more configurable windows on a display screen of a computing device. As used herein, the phrase “media effects” refers to multiple effects incorporated in a display of a content data stream, that enhance the representation or reproduction of the content data stream in a configurable window on a display screen of a computing device. The media effects comprise, for example, textual effects, audio effects, video effects, audiovisual effects, image effects, multimedia effects, message effects, augmented reality display effects, three dimensional display effects, etc., and any combination thereof. Media data can be stored, for example, as a media clip, a media message, etc., or in any digital format in the databases. The digital media parameters incorporate one or more media effects in the displayed content data streams in the configurable windows based on user preferences received via the GUI. In an embodiment, the interactive content distribution platform monitors and controls traffic of the synchronized content data streams between the computing devices during the simultaneous transmission and display of the synchronized content data streams in the configurable windows.

In an embodiment, the interactive content distribution platform manages user actions performed on the synchronized content data streams. The user actions comprise, for example, creating, modifying, deleting, or storing the synchronized content data streams. In an embodiment, the interactive content distribution platform generates recommendations on themes and genres associated with the content data streams based on the received user selections of one of the users, and transmits the generated recommendations to other users via the network, during the simultaneous display of the synchronized content data streams. In an embodiment, the interactive content distribution platform generates revenue by enabling one or more content sources, for example, global cable providers, satellite distributors, telecommunication companies, and other content providers to white label the interactive content distribution platform in their name. As used herein, the phrase “white labeling” refers to licensing products and/or services of the interactive content distribution platform to one or more content sources, for example, global cable providers, satellite distributors, telecommunication companies, or other content providers to allow them to live stream, for example, up to 30 streams of content that can be used by their subscribers on any digital device. The content sources can white label the interactive content distribution platform to simultaneously transmit and display the synchronized content data streams to one or more subscriber computing devices.

The computer implemented system disclosed herein that is used in cable, satellite and telecommunication company head ends comprises, for example, decoders, encoders, and computers selected to configure the content data streams simultaneously to a content delivery network. In an embodiment, the computer implemented method and system disclosed herein provides multiple content data streams simultaneously to a display screen at a remote location, by receiving a first content data stream simultaneously in a first content format and a second content data stream simultaneously in a different second content format; encoding the first content data stream simultaneously and the second content data stream simultaneously into a common data format or at least wrapping one of the content data streams simultaneously in a predetermined file format; passing the encoded first content data stream and the second content data stream to a content delivery network simultaneously; authenticating an instance of a player at the remote location, where the authenticated instance communicates with the display screen; transmitting the first content data stream and the second content data stream simultaneously at a transmission rate to the authenticated instance of the player simultaneously; and adjusting a transmission rate of at least one of the first content data stream and the second content data stream simultaneously in response to an available transmission rate between the content delivery network and the authenticated instance simultaneously.

In another embodiment, the computer implemented method and system disclosed herein displays a content data stream simultaneously, for example, by displaying the content data stream in a first video canvas of an authorized instance of a player associated with a first display screen; selecting the first video canvas that displays the content data stream on the first display screen; initiating a display of the first video canvas on a second display screen associated with the authorized player all simultaneously; and terminating display of the first video canvas on the first display screen.

In another embodiment, the computer implemented method and system disclosed herein provides a content data stream from a content delivery network to a first remote player and a second remote player simultaneously, by authenticating the first remote player, where the first remote player is selected to generate a display on an associated first display screen; authenticating a second remote player, where the second remote player is selected to generate a display on an associated second display screen; determining at least one of a first available transmission rate and a first transmission time between the authenticated first remote player and the content delivery network; determining at least one of a second available transmission rate and a second transmission time between the authenticated second remote player and the content delivery network; and transmitting the content data stream to the authenticated first remote player and the authenticated second remote player, where the transmission corresponds to at least one of the first available transmission rate, the first transmission time, the second available transmission rate, and the second transmission time, wherein the content data stream is displayed on the first display screen substantially simultaneous with the display of the content data stream on the second display screen, with each of the above steps performed simultaneously.

In another embodiment, the computer implemented method and system disclosed herein displays a content data stream, by authenticating a first remote instance of a player, where the player is associated with a first display screen for displaying the content data stream; displaying the content data stream in a video canvas on the first display screen; generating a second video canvas on the first display screen simultaneously in response to one of a timing of the first content data stream, a content of the first content data stream, and metadata associated with the first content data stream simultaneously; enabling a transaction through the second video canvas, independent of subsequent data in the content data stream; and closing the second video canvas upon completion of at least a portion of the transaction, with each of the above steps performed simultaneously.

The computer implemented method and system disclosed herein enhances the manner in which entertainment and communication services are delivered and presented to one or more users. The computer implemented method and system disclosed herein creates a customized multi-platform digital experience, allowing for a powerful synergy of substantial multitasking with digital content data streams, video, music, etc., in any combination being viewed, for example, from one configurable window to 30 configurable windows on a single display screen. The computer implemented method and system disclosed herein presents convergent features on one digital portal or a display screen of a computing device, for example, a digital internet device that can be connected to digital TVs, high definition televisions (HDTVs), etc., in a complete interactive social capacity. Users can simultaneously access any digital content format or the content data stream of their choosing through a digital matrix of, for example, up to 30 moveable, expandable, shrinkable, floating, interchangeable and/or shape changeable configurable viewing windows on one display screen presented on a network connected computing device. The computer implemented method and system disclosed herein enables users to enjoy live video, cable, web surfing, texting, blogging, live interactive chats either personally with multiple friends or in a group conference, social networking through social media sites, home automation, augmented reality, voice recognition, etc., purchase products viewed, for example, on any one of 30 configurable windows within the display screen by accessing any combination of digital data, or content data, or video streams within the display screen of the computing device, and share a cornucopia of digital information, for example, via text, video, electronic mail (email), live chats, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a structure or a method step referenced by a numeral in a drawing carries over to the description of that structure or method step shown by that same numeral in any subsequent drawing herein.

FIG. 1 illustrates a computer implemented method for simultaneously distributing multiple content data streams of multiple content formats to one or more computing devices.

FIG. 2 exemplarily illustrates a schematic representation of a computer implemented system for simultaneously distributing multiple content data streams of multiple content formats to one or more computing devices.

FIG. 3 exemplarily illustrates a schematic representation of an alternative configuration of components in the computer implemented system disclosed herein.

FIG. 4 exemplarily illustrates a flow diagram showing elements of a website implemented by an interactive content distribution platform for registering multiple users.

FIG. 5 exemplarily illustrates a flow chart of a login mechanism to the interactive content distribution platform implemented as a website.

FIG. 6 exemplarily illustrates a flow diagram of a process for operation of a video canvas within a player for presenting and viewing a content data stream.

FIG. 7 exemplarily illustrates a flow diagram for monitoring transmission and user metrics for controlling at least the quality of a content data stream.

FIG. 8 exemplarily illustrates a flow diagram for obfuscating content data stream names.

FIG. 9 exemplarily illustrates a schematic diagram showing components and features associated with the interactive content distribution platform.

FIG. 10 exemplarily illustrates a computer implemented system for simultaneously distributing multiple content data streams of multiple content formats to one or more computing devices.

FIG. 11 exemplarily illustrates the architecture of a computer system employed by the interactive content distribution platform for simultaneously distributing multiple content data streams of multiple content formats to one or more computing devices.

FIGS. 12A-12E exemplarily illustrate display screens of multiple types of computing devices, displaying synchronized content data streams in configurable windows.

FIGS. 13A-13F exemplarily illustrate screenshots showing a simultaneous display of multiple synchronized content data streams in multiple configurable windows on a display screen of a computing device via a graphical user interface of the interactive content distribution platform.

FIGS. 14A-14C exemplarily illustrate a flow diagram showing steps performed by a user to access the interactive content distribution platform via a social networking website, and interact with other users subscribed to the interactive content distribution platform.

### DETAILED DESCRIPTION OF THE INVENTION

The following detailed description of certain embodiments presents various descriptions of specific embodiments of the present invention. However, the present invention can be embodied in a multitude of different ways as defined and covered by the claims. In this description, reference is made to the drawings wherein like parts are designed with like numerals throughout.

The following provides a number of possible definitions of terms used in describing certain embodiments of the computer implemented method and system disclosed herein.

A network may refer to a network or a combination of networks spanning any geographical area, for example, a local area network, a wide area network, a regional network, a national network, a global network, an internet connection network, etc., or a network formed from any combination of these networks. The internet is an example of a global computer network. The network may be a hardwire network, a wireless network, or a combination of hardwire and wireless networks. Hardwire networks comprise, for example, fiber-optic lines, cable lines, integrated services digital network (ISDN) lines, copper lines, etc. Wireless networks comprise, for example, cellular systems, personal communications service (PCS) systems, satellite communication systems, packet radio systems, mobile broadband systems, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, etc. A cellular system or a mobile telecommunication network comprises, for example, a global system for mobile (GSM) communications network, a code division multiple access (CDMA) network, a third generation (3G) mobile communication network, a fourth generation (4G) mobile communication network, a long-term evolution (LTE) mobile communication network, etc. The cellular system may use, for example, CDMA, time division multiple access (TDMA), GSM, personal digital cellular (PDC), frequency division multiple access (FDMA), etc.

A website may refer to one or more interrelated web page files and other files and programs on one or more web servers. The files and programs are accessible over a network, for example, the internet, by sending a hypertext transfer protocol (HTTP) request specifying a uniform resource locator (URL) that identifies the location of one of the web page files, where the files and programs are typically owned, managed, or authorized by a single entity or business. Such files and programs comprise, for example, hypertext markup language (HTML) files, common gateway interface (CGI) files, and Java® applications. The web page files comprise, for example, a home page file that corresponds to a home page of the website. The home page can serve as a gateway or an access point to the remaining files and programs contained within the website. In an embodiment, all the files and programs are located under, and accessible within, the same network domain as the home page file. Alternatively, the files and programs can be located and accessible through several different network domains.

A web page or an electronic page may comprise content presented by a standard web browser in response to an HTTP request specifying the URL by which the web page file is identified. A web page can include or link to a variety of content, for example, text, images, audio, video, animations, etc. Content, content data, and media content may refer to electronic materials, for example, music, videos, software, books, multimedia presentations, images, text, and other electronic data, which can be delivered as a stream or transferred, for example, over a network to one or more users. Content data is typically in the form of computer files for video, audio, text, program, data, and other multimedia type content as well as actual physical copies of valuable content, for example, a compact disc read only memory (CD-ROM), a digital versatile disc (DVD), a video cassette recorder (VCR), audio, television (TV) or radio broadcast signals, streaming audio and video over networks, or other forms of conveying such information.

A computer or a computing device may be any processor controlled device that permits access to a network, for example, the internet, including a terminal device, for example, a personal computer, a mini-computer, a mainframe computer, a network of individual computers, an internet connected video gaming device, a hand-held computer, other types of network or web enabled TVs, an interactive kiosk, a mobile web browser, etc., or any combination thereof. The computing device is an electronic device, for example, a personal computer, a tablet computing device such as the iPad® of Apple Inc., a mobile computer, a mobile phone, a smart phone, a portable computing device, a laptop computer, a personal digital assistant, a wearable device such as Google Glass® of Google Inc., the iWatch of Apple Inc., etc., a touch centric device, a workstation, a server, a client device, a portable electronic device, a network enabled computing device, an interactive network or web enabled wireless communications device, a gaming device, a set top box, a television, an image capture device, a web browser, a portable media player such as the iPod® of Apple Inc., a video recorder, a global positioning system (GPS) device, a theater system, any entertainment system, any other suitable computing equipment, and combinations of multiple pieces of computing equipment, etc. The electronic device may also be a hybrid device that combines the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing. Computing equipment may be used to implement applications such as media playback applications, for example, iTunes® from Apple Inc., a web browser, a mapping application, an electronic mail (email) application, a calendar application, etc. Computing equipment, for example, one or more servers may be associated with one or more online services. The computing devices may further possess one or more input devices, for example, a keyboard, a mouse, a touch pad, a joystick, a pen-input-pad, etc. The computing device may also possess an output device, for example, a display screen, an audio output or speakers, etc.

These computers may be uni-processor or multi-processor machines. Moreover, the computers may include an addressable storage medium or a computer accessible medium, for example, a random access memory (RAM), an electronically erasable programmable read-only memory (EEPROM), a programmable read-only memory (PROM), an erasable programmable read-only memory (EPROM), hard disks, floppy disks, laser disk players, digital video devices, compact disks, video tapes, audio tapes, magnetic recording tracks, electronic networks, and other techniques to transmit or store electronic content. In an embodiment, the computers are equipped with a network communication device such as a network interface card, a modem, or another network connection device suitable for connecting to the network. Furthermore, the computers execute an appropriate operating system, for example, Linux®, Unix®, any version of Microsoft® Windows®, the Mac OS of Apple Inc., the IBM® OS/2, or any other operating system. The appropriate operating system may include a communications protocol implementation that handles all incoming and outgoing message traffic passed over the network. In other embodiments, while the operating system may differ depending on the type of computer, the operating system continues to provide the appropriate communications protocols to establish communication links with the network, for example, the internet.

The computers may contain program logic or another representation of data and instructions, which cause the computer to operate in a specific and predefined manner. In an embodiment, the program logic may be implemented as one or more programs residing on or accessible by the computer. The functionality provided in the components, programs, and one or more databases may be combined into fewer components, programs, or databases or further separated into additional components, programs, or databases. Furthermore, the components, the programs, and the databases may be implemented to execute on one or more computers. In an embodiment, some of the components, programs, and databases may be implemented to execute on one or more computers external to the website. In this instance, the website includes program logic, which enables the website to communicate with the externally implemented components, programs, and databases to perform the functions as disclosed herein.

A content delivery network (CDN) comprises one or more suitable internet protocol based networks for transmitting content data such as multimedia content to servers or remote users. A CDN service provider typically maintains a number of computers in a network that can maintain content from various content providers. In turn, content providers can instruct, or otherwise suggest to, client computing devices to request some, or all, of the content provider's content from the computers of a particular CDN service provider. In an embodiment, the CDN is load balanced and fault tolerant at the client level.

The hardware assembly or software broadcast nodes provide encoded content data streams to computing devices. The broadcast nodes provide inline transcoding of the content data streams from integrated receiver/decoders (IRDs). In an embodiment, the broadcast node encodes one channel, for example, into HTML technology to retain the additional features or data such as surround sound. The requisite hardware assembly can be provided in a self-contained unit (SCU) which can include computers or servers, with appropriate inputs and outputs and with the presently described programs for implementing the disclosed functionality. Thus, an independent content provider can offer their content with the interactivity of the computer implemented system disclosed herein by employing an SCU. In an embodiment, the independent provider can pass the content data from a camera, or post production, through the SCU, wherein the content is then distributed to the content delivery network (CDN) or a conventional content delivery system. In another embodiment, the content data passing through the SCU can be digitally wrapped as set forth below. In conjunction, or as an alternative to the CDN, broadcast nodes can be employed, wherein the broadcast node functions as a virtual CDN. The broadcast node includes the servers and associated software for transcoding the content data streams, on the fly as more fully set forth herein.

Social media comprises media designed to be disseminated through social interaction, created using highly accessible and scalable publishing techniques. Social networks employ internet and web based technologies to transform broadcast media monologues, one to many, into social media dialogues, many to many. Social networks incorporate social media, which can take many different forms, for example, internet forums, weblogs, social blogs, wikis, podcasts, pictures, video, rating, bookmarking, etc. Technologies comprise, for example, blogs, picture-sharing, wall-postings, electronic mail (email), instant messaging, music sharing, crowd sourcing, as well as voice over internet protocol (VoIP). Many of these social media can be integrated via social network aggregation platforms comprising, for example, Mybloglog and Plaxo® of Plaxo, Inc.

Examples of social media communication software applications comprise, for example, blogs such as Slogger, LiveJournal® of Primordial Soup Ltd., Open Diary, TypePad° of Six Apart Ltd., WordPress® of WordPress Foundation, Vox® and VOXopolis® of Voxopolis Inc., ExpressionEngine® of PMachine, Inc., Xanga® of Xanga.com, Inc.; micro-blogging and presence applications comprising, for example, Twitter® of Twitter, Inc., Plurk, Tmblr.® of Tumblr, Inc., Jaiku® of Google, Inc., Fmylife®; social networking websites such as Bebo® of Bebo, Inc., Facebook® of Facebook, Inc., Linkedin® of Linkedin Corporation, MySpace® of MySpace Inc., Orkut® of Google, Inc., Skyrock®, Hi5® of Hi5 Networks, Inc., Ning® of Ning, Inc., Elgg; and social network aggregation applications such as NutshellMail, FriendFeed® of Facebook, Inc., etc.

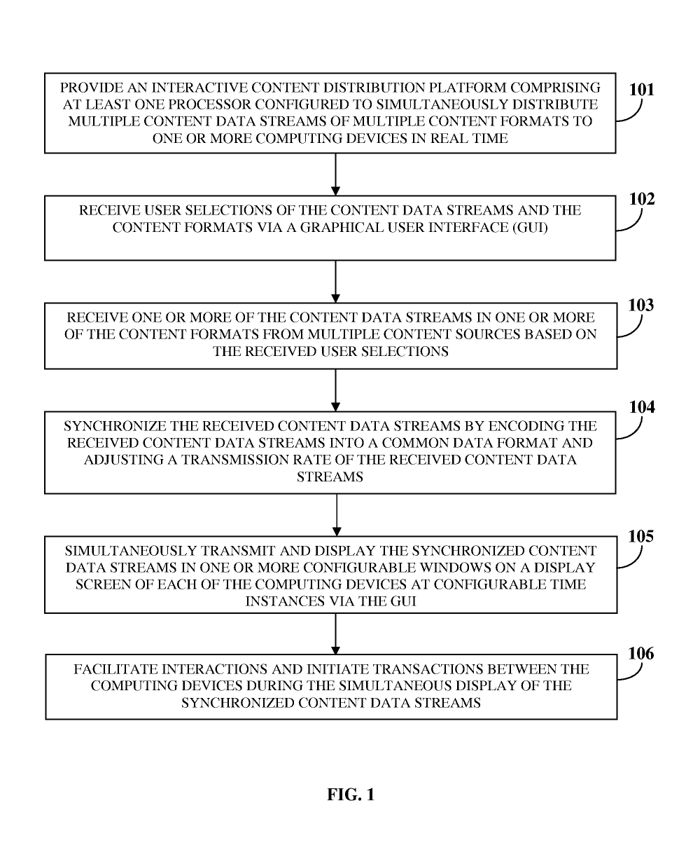

FIG. 1 illustrates a computer implemented method for simultaneously distributing multiple content data streams of multiple content formats to one or more computing devices. The content data streams comprise, for example, live cable television (TV) content, live high definition streaming content, multimedia chat content such as video chat content, audio chat content or text chat content, live multimedia chat content, video conferencing content, gaming content, web browsing content, video-on-demand content, home automation content, augmented reality content, voice recognition content, social media networking content, live video content, canned video content, digital video recorder video content, user generated content, message content, electronic mail (email) content, audio content, three-dimensional media content, electronic commerce content, information, blog content, analytical information of viewed content, multimedia content, etc., and any combination thereof. The computer implemented method disclosed herein provides 101 an interactive content distribution platform comprising at least one processor configured to simultaneously distribute the content data streams of different content formats to one or more computing devices in real time. The interactive content distribution platform streams multiple live content data streams simultaneously on any digital device. The interactive content distribution platform is accessible to users, for example, through a broad spectrum of technologies and devices such as personal computers with access to the internet, internet enabled cellular phones, tablets, etc. In an embodiment, the interactive content distribution platform is implemented as a software as a service (SaaS).

In another embodiment, the interactive content distribution platform is implemented in a cloud computing environment. As used herein, the phrase “cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The interactive content distribution platform is a cloud computing based platform implemented as a service for simultaneously distributing multiple content data streams of multiple content formats to one or more computing devices. The interactive content distribution platform is developed, for example, using the Google App engine cloud infrastructure of Google Inc. With access to the interactive content distribution platform, a user need not purchase any additional device, for example, a set-top box, etc., to access television channels in addition to accessing the internet using a computing device, for example, a laptop, a smart phone, any broadband connected digital device, etc. The user can simultaneously access, for example, up to 30 digital content data streams on a website provided by the interactive content distribution platform. The interactive content distribution platform displays any number of digital content data streams simultaneously on a display screen of a user's computing device or any internet connected computing device or a digital computing device.

The interactive content distribution platform is configured to provide a graphical user interface (GUI) accessible by each of the computing devices via a network. The graphical user interface is, for example, a web page of a website hosted by the interactive content distribution platform, an online web interface, a web based downloadable application interface, a mobile based downloadable application interface, etc. The network is, for example, a content delivery network, the internet, etc. In an embodiment, the interactive content distribution platform is configured as a website for distributing the content data streams converted into a common data format to any digital computing device, where each content data stream is encrypted and transmission of the content data stream is a function of available transmission rates to a computing device. In this embodiment, the interactive content distribution platform operates as a web site on any computing device.

The interactive content distribution platform receives 102 user selections of the content data streams and the content formats via the GUI. The interactive content distribution platform receives the user selections through one or more of multiple communication modes comprising, for example, a voice mode, a video mode, a text mode, a multimedia mode, a telephonic mode, etc., any combination thereof. For example, the user may request for or select specific content data streams using a voice mode that is recognized by the interactive content distribution platform. The user can request any information and the interactive content distribution platform responds by presenting the information requested on a configurable window on a display screen of the user's computing device. The interactive content distribution platform provides a voice recognition facility to allow the users to request specific content data streams or any digital data in a complete interactive environment. Consider an example where a user wishes to retrieve information related to a specific content data stream. The user can use voice recognition facility provided by the interactive content distribution platform in order to provide user preferences or user selections to the interactive content distribution platform. For example, the user can give a voice command to the interactive content distribution platform that is received by one or more sensor components in operative communication with the user's computing device. In an example, while watching a video via the GUI of the interactive content distribution platform, the user can provide a voice command that requests the interactive content distribution platform to search for social media content associated with social networking and transmit the search results to the user's electronic mail (email) account. Hence, the user can simultaneously view search results on the display screen of the computing device, download and/or print a copy of the search results transmitted by the interactive content distribution platform, while watching the video.

The interactive content distribution platform receives 103 one or more of the content data streams in one or more of the content formats from multiple content sources based on the received user selections. For example, the interactive content distribution platform receives the content data streams in different content formats from disparate content sources such as the internet, a cable provider, a satellite distributor, a telecommunication company, a social networking platform, etc. The interactive content distribution platform synchronizes 104 the received content data streams, for example, by encoding the received content data streams into a common data format and adjusting a transmission rate of the received content data streams.

The interactive content distribution platform simultaneously transmits and displays 105 the synchronized content data streams in one or more configurable windows on a display screen of each of the computing devices at configurable time instances via the GUI. As used herein, the phrase “time instances” refers to instances of time configured by the interactive content distribution platform or configured based on user preferences for simultaneously transmitting and displaying content data streams. The time instances are, for example, one at a time or all at the same time. The configurable windows can be moved, expanded, shrunk, and/or interchanged across the display screen of each computing device. In an embodiment, the configurable windows are configured as floating windows. The synchronized content data streams in each of the configurable windows are changeable based on the received user selections. By utilizing multiple moveable, expandable, shrinkable, floating, interchangeable, and/or shape changeable configurable windows, the interactive content distribution platform simultaneously displays, for example, up to 30 constantly changeable content data streams within the display screen, either one at a time or up to 30 content data streams simultaneously through the single GUI of the interactive content distribution platform.

The interactive content distribution platform is configured to import, for example, up to 30 digital content data or video streams into each and every configurable window at a time on the display screen, thereby increasing the amount of viewing experiences, multitasking capabilities, and the presentation of the content data streams on the display screen. The interactive content distribution platform allows the user to experience an infinite number of viewing possibilities and have infinite access to an increased amount of digital data and fast sharing capabilities on the network, for example, the internet. The interactive content distribution platform provides a customized multi-platform digital experience, allowing for a powerful synergy of substantial multitasking with digital data, content data streams, video, music, etc., rendered in any combination ranging from one configurable window and increasing, for example, up to 30 configurable windows. The GUI is configured to allow a user to view the configurable windows, for example, with video and available game content. In an embodiment, each of the received content data streams is accessible via a link and is configured to serve as a gateway to one or more of other content data streams.

The interactive content distribution platform enables a user to view, for example, 30 digital content data streams simultaneously on a single display screen via the GUI of the interactive content distribution platform, thereby allowing the user to multitask and perform multiple different activities simultaneously. In an embodiment, the interactive content distribution platform configures one or more digital media parameters for incorporating one or more media effects in the displayed content data streams in one or more configurable windows on a display screen of a computing device. As used herein, the phrase “media effects” refers to multiple effects incorporated in a display of a content data stream, that enhance the representation or reproduction of the content data stream in a configurable window on a display screen of a computing device. The media effects comprise, for example, textual effects, audio effects, video effects, audiovisual effects, image effects, multimedia effects, message effects, augmented reality display effects, three dimensional display effects, etc., and any combination thereof. Media data can be stored, for example, as a media clip, a media message, etc., or in any digital format in one or more databases. The digital media parameters incorporate one or more media effects in the displayed content data streams in one or more configurable windows based on user preferences received via the GUI. Consider an example where a user wishes to incorporate one or more media effects, for example, an augmented reality display effect, a three dimensional display effect, etc., to the content data stream viewed by the user on the display screen of the user's computing device via the interactive content distribution platform. The interactive content distribution platform provides the user with multiple options for the media effects. The user can access the options via the GUI and select one of the options to apply on the display of the viewed content data stream. If the user selects the three dimensional display option via the GUI, then the interactive content distribution platform displays the content data stream in a three dimensional display environment. The user can change the display of the content data stream to a two dimensional display by changing display settings via the GUI of the interactive content distribution platform.

The interactive content distribution platform facilitates interactions and initiates transactions 106 between the computing devices during the simultaneous display of the synchronized content data streams in different configurable windows on the display screen of each of the computing devices via the GUI. For example, the interactive content distribution platform automatically transmits and displays one or more notifications and content in one or more configurable windows on the display screen of each of the other computing devices of one or more users who are viewing the synchronized content data streams on the other computing devices via the GUI. The interactive content distribution platform automatically transmits and displays, for example, a text alert and actual data images whether they are video or content data streams to the user's friends, family and other users who are viewing content data streams on other computing devices, to allow the user to share the content data streams automatically without having to notify the other users. In another example, the interactive content distribution platform automatically transmits and displays one or more advertisements being viewed by one of the users to the configurable windows on the display screen of each of the other users who are viewing the synchronized content data streams on the other computing devices via the GUI. When a user is watching an advertisement along with other content data streams on a display screen of the user's computing device, the interactive content distribution platform automatically transmits the same advertisement to other users who are viewing the content data streams on other computing devices, thereby allowing the other users to automatically receive the user's viewing preferences at the same time. In an embodiment, the interactive content distribution platform transmits a notification to the other users to receive approval from the other users before transmitting the content data streams to the other users via the GUI of the interactive content distribution platform.

Consider an example where a user wishes to transmit a content data stream to another user who uses another computing device. The user subscribes to and logs in to the interactive content distribution platform. In an embodiment, the user sends an invitation to another user via an electronic mail (email), requesting the other user to subscribe to the interactive content distribution platform. In another embodiment, the user can transmit or import content data streams from the other user's computing device without the need for the other user to subscribe to the interactive content distribution platform. The user sends a video file to the other user via the network of the interactive content distribution platform. The interactive content distribution platform automatically encodes the video file and transmits the encoded video file to the other user's computing device. The user need not wait for the other user to verify the request sent by the user, and the other user can directly view the sent video file on a display screen of the other user's computing device. Similarly, the user can import or receive content data streams from the other user via the network. In an embodiment, the user can store the video file sent to and/or received from the other user in one or more databases of the interactive content distribution platform.

Consider another example where a user wishes to transmit a video clip of a video content to another user or a group of users while watching video content via the interactive content distribution platform. The video content is, for example, an advertisement, a movie, a television show, a sports game, etc. The user subscribes to and logs in to the interactive content distribution platform. After successful registration of the user with the interactive content distribution platform, the interactive content distribution platform dynamically integrates the users' social networking site's contact lists or phone contact lists into the interactive content distribution platform. The user can form user groups or friend circles on the interactive content distribution platform. The user group comprises account information of other users who are registered with the interactive content distribution platform. If the user wishes to add a friend who is in the phone contact list but not subscribed to the interactive content distribution platform, then the user can transmit an invitation to the other user via the network of the interactive content distribution platform. The interactive content distribution platform acts as a portal for users' personal networks, granting access to all websites and functionalities.

The other users may or may not be logged in to the interactive content distribution platform. The user can record the video clip while watching the video content and transmit the recorded video clip embedded in a notification to the other user or the group of users via the network. If the other user or the group of users is logged in to the interactive content distribution platform, the video clip is directly displayed on the display screen of their computing devices via the GUI of the interactive content distribution platform. If the other user or the group of users is not presently logged in to the interactive content distribution platform, then the interactive content distribution platform stores the video clip in a database of the interactive content distribution platform and displays the video clip on the display screen of their computing devices when the other user/users log in to the interactive content distribution platform.

In an embodiment, the interactive content distribution platform generates recommendations on themes and genres associated with the content data streams based on the received user selections of one of the users and transmits the generated recommendations to other users via the network, during the simultaneous display of the synchronized content data streams. The interactive content distribution platform recommends and suggests associated themes and genres to the user and other users, for example, on similar preferred viewing formats, programming, themes, categories, etc. Consider an example where a user wishes to change one or more display features, for example, a background display, a theme, a genre, etc., associated with a content data stream streamed to his/her display screen of a computing device. In an embodiment, the interactive content distribution platform generates recommendations for the display features, and transmits the recommendations to the user via the network. The user may use one or more of the display features from the recommendations generated by the interactive content distribution platform. In another embodiment, the user can create or use the display features based on inputs received from other users via the interactive content distribution platform or external sources, for example, by browsing the internet, and dynamically apply the self-generated display features on the content data stream viewed by the user via the GUI. The interactive content distribution platform offers live cable content and/or channels and allows the users to classify the content data streams into categories and groups that other users can choose by their preferences.

The interactive content distribution platform makes digital content, for example, live video, canned video, user generated content, gaming content, etc., available to an authenticated user and an authenticated user group. The interactive content distribution platform has interactive capabilities via content data and video streams that allow for interactions from the user back to the interactive content distribution platform or between groups of users. This allows for social and transactional capabilities, for example, micro-transactions, social viewing between groups, etc., via the interactive content distribution platform.

In an embodiment, the interactive content distribution platform generates revenue by enabling white labeling of the interactive content distribution platform by one or more of the content sources, for example, global cable providers, satellite distributors, telecommunication companies, and other content providers, to allow the content sources to simultaneously transmit and display the synchronized content data streams to one or more subscriber computing devices. That is, the interactive content distribution platform generates revenue by allowing one or more content sources to white label the interactive content distribution platform in their name. As used herein, the phrase “white labeling” refers to licensing products and/or services of the interactive content distribution platform to one or more content sources, for example, global cable providers, satellite distributors, telecommunication companies, or other content providers to allow them to live stream, for example, up to 30 streams of content that can be used by their subscribers on any digital device. The cable and/or video distributors can white label the interactive content distribution platform to simultaneously transmit and display the synchronized content data streams to one or more subscriber computing devices. The interactive content distribution platform is configured to connect to existing user and billing systems as part of the white label mechanism. This allows the interactive content distribution platform to extend the existing offerings of a small to mid-size cable provider, while leveraging existing customer relationships. The interactive content distribution platform avoids the infrastructure costs associated, for example, with management of a typical billing system, customer services, content ownership, etc., since these are already in place. Moreover, since information associated with the user is already known by the interactive content distribution platform, all application purchases can be routed through the existing billing system using profiles of the users registered with the interactive content distribution platform. The interactive content distribution platform offers the content sources, for example, owners of the content data streams, immediate multi-platform distribution access for their programming with monetization of the content data streams primarily driven by subscription fees, pay-per-view (PPV), video on demand (VOD), advertising, demographic targeting, etc. The incorporation of the white labeling mechanism by the interactive content distribution platform provides the content sources, for example, the global cable providers, the satellite distributors, telecommunication companies, or the content providers with much needed added value, multi-platform presence, and a larger subscriber proposition. The white labeling mechanism enhances the digital experience for the existing subscribers of the content sources and adds a premium and incremental revenue stream for the content sources, and helps the content sources to regain lost market share due to online video explosion.

A mid-sized video cable market has a subscriber base ranging, for example, from about 150,000 to about 1 million subscribers. There are over 5,000 cable operators or cable providers worldwide that are losing market share due to the online video explosion and require an affordable solution to their challenges. The interactive content distribution platform provides that solution cost effectively. As part of the interactive content distribution platform's multiple-revenue generation model, the interactive content distribution platform implements the white labeling mechanism and monetizes the white labeling mechanism by driving substantial revenue streams from licensing transactions with the content sources. Consider an example where a cable operator signs a white labeling agreement with the interactive content distribution platform. The interactive content distribution platform receives an upfront licensing fee from the cable operator in the range of, for example, about $2.5 million to about $20 million depending upon the number of subscribers that the cable operator services. A per subscriber fee of, for example, about $0.25 is attached to the ongoing licensing agreement with the cable operator.

Consider an example where a content source, for example, a cable provider wishes to provide a cable service to one or more customers using the white labeling mechanism provided by the interactive content distribution platform. The content source subscribes to the interactive content distribution platform and signs a white label agreement with the interactive content distribution platform. As per the white label agreement, the cable provider, in communication with the interactive content distribution platform, provides the cable service to customers of the cable provider via the network of the interactive content distribution platform. Information of the customers of the content source is stored in one or more databases maintained by the interactive content distribution platform. The cable and/or video distribution providers per customer who are using the content data streams provided by the respective content sources via the interactive content distribution platform are charged. For example, the cable providers pay the interactive content distribution platform a licensing fee per the white label agreement.

The interactive content distribution platform is configured to pull in content data streams and push/pull user information back into a user management system. In an embodiment, the interactive content distribution platform monitors and controls traffic of the synchronized content data streams between the computing devices during the simultaneous transmission and display of the synchronized content data streams in the configurable windows. The interactive content distribution platform comprises a central server configured to manage stream traffic between client computing devices. The interactive content distribution platform enables multiple computing devices to access any or all of, for example, 30 independent content data streams within each particular computing device by preference through configurable windows that are instantly changeable, moveable, expandable, shrinkable, etc.

In an embodiment, the interactive content distribution platform manages user actions performed on the synchronized content data streams. The user actions comprise, for example, creating, modifying, deleting, storing, etc., the synchronized content data streams. Consider an example where a user wishes to upload a content data stream, for example, a self-generated music video on the interactive content distribution platform. The user logs in to the interactive content distribution platform using a computing device, for example, a smart phone. The user can record the music video in real time while logged in to the interactive content distribution platform using the computing device via the GUI of the interactive content distribution platform. The user uploads the recorded music video on the interactive content distribution platform via the GUI. Once the music video is uploaded on the interactive content distribution platform, the user can also modify or delete the uploaded music video. Similarly, multiple content data streams can be created, modified, deleted, stored, etc., by the user using the computing device via the GUI of the interactive content distribution platform.

In an embodiment, the computer implemented method disclosed herein simultaneously provides multiple content data streams to a display screen as follows. The interactive content distribution platform receives a first content data stream and a second content data stream simultaneously. The interactive content distribution platform then encodes at least one of the first content data stream and the second content data stream and/or wraps at least one of the first content data stream and the second content data stream in a predetermined file format simultaneously. The interactive content distribution platform simultaneously passes the first content data stream and the second content data stream to the network, for example, the content delivery network. The interactive content distribution platform authenticates an instance of a player at a remote location, where the authenticated instance communicates with a display screen of a computing device. The interactive content distribution platform simultaneously transmits the first content data stream and the second content data stream at a transmission rate to the authenticated instance of the player. The interactive content distribution platform simultaneously adjusts a transmission rate of at least one of the first content data stream and the second content data stream in response to an available transmission rate between the content delivery network and the authenticated instance of the player. In an embodiment, the interactive content distribution platform displays the first content data stream in a first video canvas on the display screen, and displays the second content data stream in a second video canvas on the display screen. In an embodiment, the interactive content distribution platform receives a user generated content data stream from the authenticated instance of the player and encodes the user generated content data stream.

In another embodiment, the computer implemented method disclosed herein simultaneously displays a content data stream as follows. The interactive content distribution platform displays the content data stream on a first video canvas of an authorized instance of a player associated with a first display screen. The interactive content distribution platform selects the first video canvas that displays the content data stream on the first display screen, and simultaneously initiates a display of the first video canvas on a second display screen associated with the authorized player. The interactive content distribution platform terminates display of the first video canvas on the first display screen. In an embodiment, the interactive content distribution platform initiates a display of the first video canvas on a second display screen in response to a movement of the first video canvas on the first display screen.

In another embodiment, the computer implemented method disclosed herein simultaneously displays a content data stream as follows. The interactive content distribution platform displays the content data stream in a first video canvas of an authorized instance of a player associated with a first display screen. The interactive content distribution platform monitors a location of the first video canvas on the first display screen. The interactive content distribution platform initiates a control program displayed on a second video canvas displayed on a different second display screen. The interactive content distribution platform alters a display of the first video canvas on the first display screen in response to an input at the control program.

In another embodiment, the computer implemented method disclosed herein simultaneously provides a content data stream from the content delivery network to a first remote player and a second remote player as follows. The interactive content distribution platform authenticates the first remote player, where the first remote player is selected to generate a display on an associated first display screen. The interactive content distribution platform authenticates a second remote player, where the second remote player is selected to generate a display on an associated second display screen. The interactive content distribution platform determines at least one of a first available transmission rate and a first transmission time between the authenticated first remote player and the content delivery network. The first transmission time is an average transmission time between the authenticated first remote player and the content delivery network. The interactive content distribution platform determines at least one of a second available transmission rate and a second transmission time between the authenticated second remote player and the content delivery network. The second transmission time is an average transmission time between the authenticated second remote player and the content delivery network. In an embodiment, the first available transmission rate and the second available transmission rate are different. The interactive content distribution platform simultaneously transmits the content data stream to the authenticated first remote player and the authenticated second remote player, where the transmission corresponds to at least one of the first available transmission rate, the first transmission time, the second available transmission rate, and the second transmission time. The interactive content distribution platform displays the content data stream on the first display screen substantially simultaneous with the display of the content data stream on the second display screen. In an embodiment, the interactive content distribution platform passes a user generated content data stream from the authenticated first remote player to the authenticated second remote player.

In another embodiment, the computer implemented method disclosed herein displays a content data stream as follows. The interactive content distribution platform authenticates a first remote instance of a player, where the player is associated with a first display screen for displaying the content data stream. The interactive content distribution platform displays the content data stream in a video canvas on the first display screen. The interactive content distribution platform simultaneously generates a second video canvas on the first display screen in response to a timing of the first content data stream, a content of the first content data stream, and/or metadata associated with the first content data stream. The interactive content distribution platform simultaneously enables a transaction through the second video canvas, independent of subsequent data in the content data stream. The interactive content distribution platform closes the second video canvas upon completion of at least a portion of the transaction. In an embodiment, the interactive content distribution platform generates the second video canvas at a predetermined interval of the content data stream.

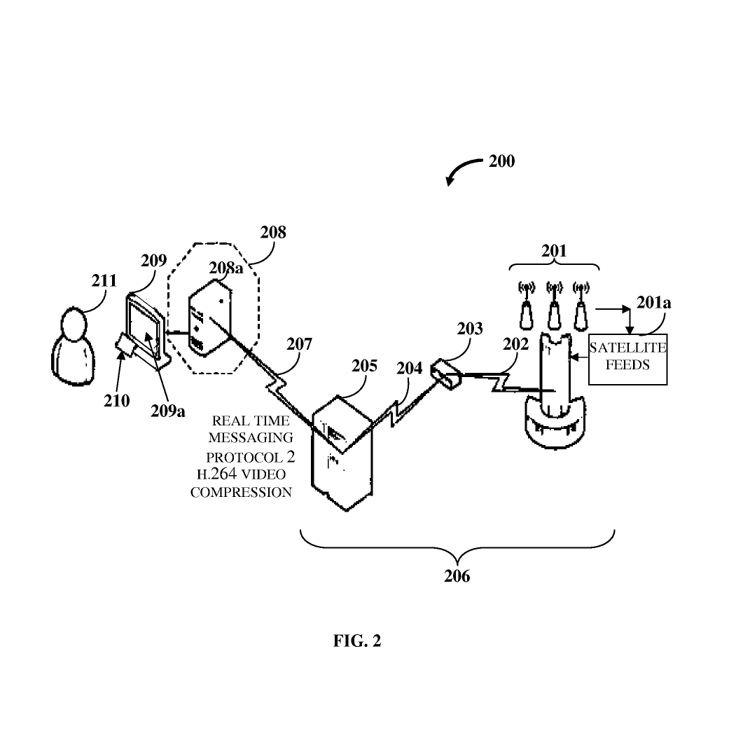

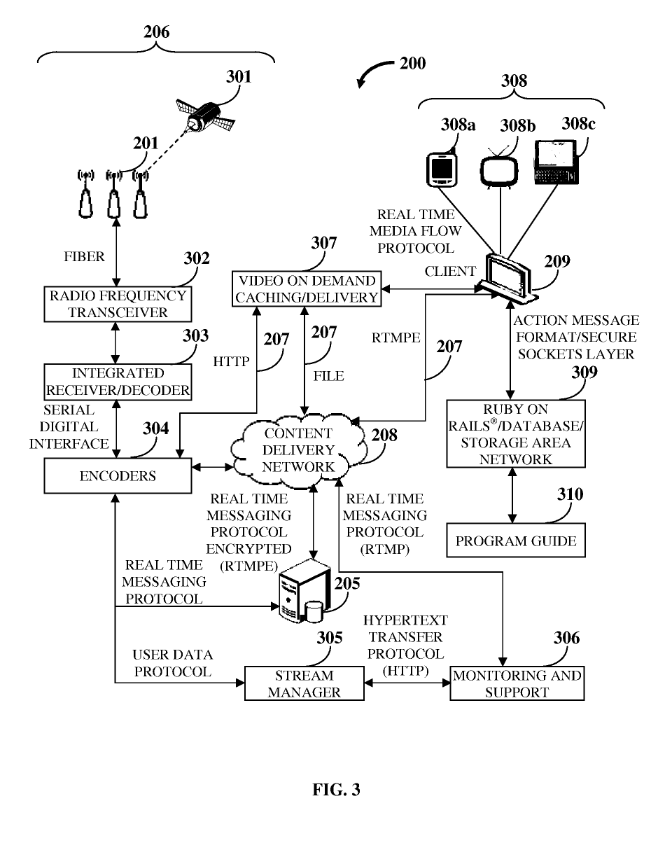

FIGS. 2-3 exemplarily illustrate schematic representations of a computer implemented system 200 for simultaneously distributing multiple content data streams 207 of multiple content formats to one or more computing devices 209. Referring to FIG. 2, the computer implemented system 200 disclosed herein comprises the interactive content distribution platform implemented as a website and accessible from a network or a content delivery network (CDN) 208, for example, the internet, wherein the interactive content distribution platform provides content data streams 207 and interactive communication to remote computing devices 209 by virtue of a player operating within a browser on the remote computing devices 209. In an embodiment, each of the remote computing devices 209 comprises a display screen 209a and an image capture device 210, for example, a commercially available web camera or a video camera connected to the computing device 209. However, it is understood that the computer implemented system 200 disclosed herein does not require an image capture device 210. In an embodiment, multiple peer computing devices 308, comprising, for example, a smart phone 308a, a television 308b, a personal digital assistant (PDA) 308c, etc., are operatively connected to a client computing device 209 using real time media flow protocol (RTMFP) connection as exemplarily illustrated in FIG. 3.

The computer implemented system 200 disclosed herein comprises a satellite receiver or a satellite receiver array 201, decoders such as integrated receiver/decoders (IRDs) 303, encoders 304, transcoders 203, and application servers 205 comprising, for example, an HTML media server, the Adobe® media interactive server, etc. In an embodiment, at least some of the content data streams 207 are received from satellite transmissions, and thus the content data streams 207 enter the computer implemented system 200 at the satellite receiver or the satellite receiver array 201 as satellite feeds 201a. The satellite feeds 201a then pass to the decoders, for example, the IRDs 303 or an internet datagram protocol (IDP) transcoder 203 via a moving picture experts group (MPEG-2) transmission path 202. The satellite receiver or the satellite receiver array 201 receives content data streams 207 from various content providers. Furthermore, the computer implemented system 200 can receive a channel stream at the head end 206 from the network 208, for example, a virtual private network (VPN). Thus, such input does not pass through the satellite receiver or the satellite receiver array 201 and the IRDs 303.

The integrated receiver/decoders (IRDs) 303 are used for the reception of contribution feeds intended for re-broadcasting through the content delivery network 208, or broadcast nodes. The IRD 303 is an interface between the receiving satellite receiver array 201 or networks and the encoder 304. Digital broadcast streams received via the satellite receiver array 201 are decoded by the IRDs 303, wherein the output is passed to the encoders 304. The encoders 304 encode content data streams 207 to a predetermined content format, for example, a content format compatible with the Adobe® Flex Builder software of Adobe Systems Incorporated. The encoder 304 encodes the content data streams 207 to a multitude authoring program, for example, Adobe® Flex Builder software of Adobe Systems Incorporated or QuickTime® of Apple, Inc., as set forth below. Encoding includes, for example, H.264 encoding supported by the HTML media server. Encryption can be provided, for example, by Adobe® media rights management server implementation, for example, a real time messaging protocol (RTMP) or a real time messaging protocol encrypted (RTMPE) implementation. In an embodiment, each individual content data stream 207 is encrypted. For example, the content data streams 207 can be delivered to an authenticated instance of the player via an advanced encryption standard (AES) encrypted transmission control protocol (TCP) connections to the content delivery network (CDN) 208. The encoders 304 generate content data streams 207, which are sent to the Adobe® Flex Builder software at the head end 206, which forwards the content data stream 207 to the CDN 208 or the broadcast nodes.

In an embodiment, the content data streams 207 are delivered via the real time messaging protocol (RTMP) and the real time messaging protocol encrypted (RTMPE) using the HTML media server software from a network hub to a last network node. In an embodiment, the content data streams 207 from the encoders 304 are sent by a private network to the Adobe® Flex Builder software, wherein the content data streams 207 are then passed from the Adobe® Flex Builder software to the content delivery network (CDN) 208 by virtue of token authentication. The transcoding and aggregation are performed on a redundantly secured private network to prevent breaches of content data during the transcoding process. Permanent storage of the content data streams 207 is also within a private network and is relayed to caching servers, for example, the Adobe® Flex Builder software and the CDN 208 as needed. The head end 206 can include redundancy to address potential hardware failure. The encoded and encrypted content data stream 207 passes from the encoders 304 at the head end 206 for distribution to remote client computing devices 209, as well as selective temporary archive, such as digital video recording.

As exemplarily illustrated in FIG. 2, a content data stream is received at the satellite receiver array 201 as a satellite feed 201a and can be passed to the internet datagram protocol (IDP) transcoder 203 in a first content format, wherein the IDP transcoder 203 transcodes or converts the format of the content data stream to a predetermined content format to generate a transcoded content data stream 204. The transcoded content data stream 204 then passes, for example, to the Adobe® Flex Builder software in the application server 205, where the content data stream 207 is encrypted and passed to a processor, a central processing unit (CPU) 208a, or the content delivery network (CDN) 208, and then to the authenticated instance of the player associated with the particular subscribed user 211.

Referring to FIG. 3, content data can be received at the satellite receiver array 201, is passed through a radio frequency (RF) transceiver 302, the integrated receiver/decoders (IRDs) 303, and the encoders 304. From the encoders 304, the content data streams 207 can be provided to the content delivery network (CDN) 208 and/or a video on demand (VOD) system 307 for caching and delivering a given content data stream 207 to a player instance in response to an authenticated access request. The interactive content distribution platform further comprises a program guide 310. The program guide 310 provides information associated with the content data streams 207 to the users 211 exemplarily illustrated in FIG. 2, via a graphical user interface (GUI) of the interactive content distribution platform. In conjunction, the information/data associated with the content data streams 207 is transmitted from the program guide 310 to the client computing devices 209 through the Ruby on Rails® system associated databases and a storage area network (SAN) 309 using an action message format (AMF) or secure sockets layer (SSL) connection.

FIG. 3 exemplarily illustrates a schematic representation of an alternative configuration of the components in the computer implemented system 200 disclosed herein. The schematic representation depicts the internet streaming of interactive television content by the interactive content distribution platform. As with a conventional television system, the satellite receiver array 201 is physically mounted and aimed in a direction and elevation in order to have a clear view of the sky in the direction in which the satellite receiver array 201 is aimed. The satellite receiver array 201 receives broadcast signals from a satellite 301. Multiple runs of fiber optic cable traverse from a building on which the satellite receiver array 201 is mounted. Splitters connected to each satellite dish in the satellite receiver array 201 split the broadcast satellite signals to a series of integrated receiver/decoders (IRDs) 303. The IRDs 303 receive broadcast satellite signals from the satellite receiver array 201 via the radio frequency (RF) transceiver 302 and decode the received broadcast satellite signals. In an embodiment, there is one IRD 303 per transmission channel. Digital IRDs 303 deliver a video signal on a serial digital interface (SDI) output. The encoders 304 then convert the SDI feed through a series of steps to produce encoded feeds for a software, for example, the Adobe® Flex Builder software stored in the application server 205. The encoded feeds from the encoders 304 are passed through the application server 205, for example, using a real time messaging protocol (RMTP) before distribution to the content delivery network (CDN) 208 using the real time messaging protocol encrypted (RMTPE). This allows for manipulation of the encoded feeds using technologies such as digital rights management (DRM) and extraction and/or addition of metadata into the content data stream 207. Cached static and/or live content is streamed and cached in the CDN 208.

The encoders 304 transmit the encoded feeds to a stream manager 305 using a user data protocol (UDP) connection. The stream manager 305 transmits the encoded content data streams 207 to a monitoring and support component 306 using a hypertext transfer protocol (HTTP) connection. The monitoring and support component 306 manages administrative and/or advertising functions performed by the interactive content distribution platform. The monitoring and support component 306 resources and manages the content data streams 207, user generated content data streams 207, scheduling of the content data streams 207, etc. Advertisers and content providers can also see the effectiveness of their campaigns in real time and the status of how their content data streams 207 are interacted with. In an embodiment, the interactive content distribution platform allows the advertisers to insert advertisement content in the content data streams 207 and tag the content data streams 207 for demographic targeting. The monitoring and support component 306 communicates with the content delivery network (CDN) 208 via the real time messaging protocol (RTMP).

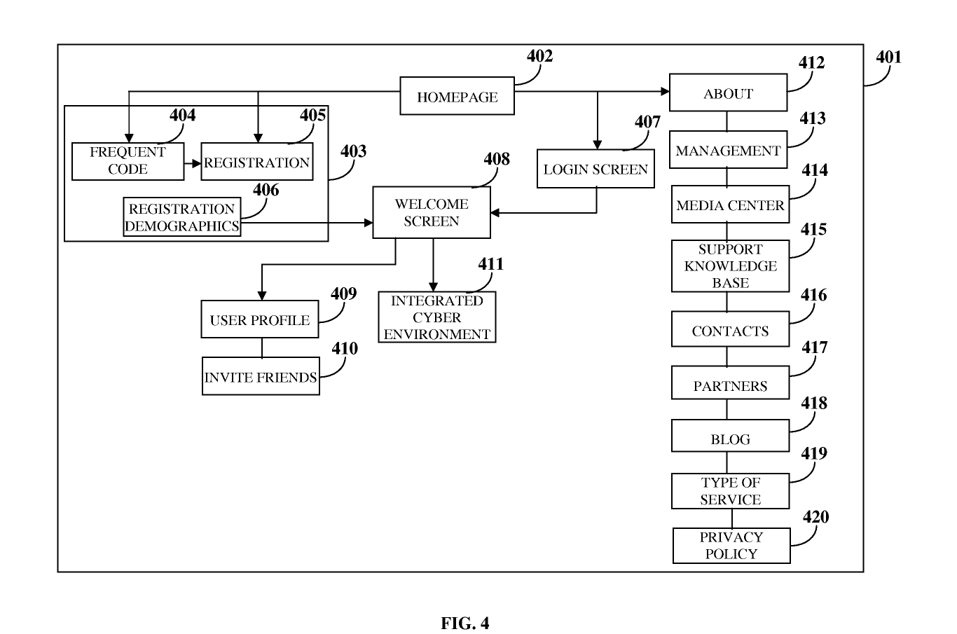

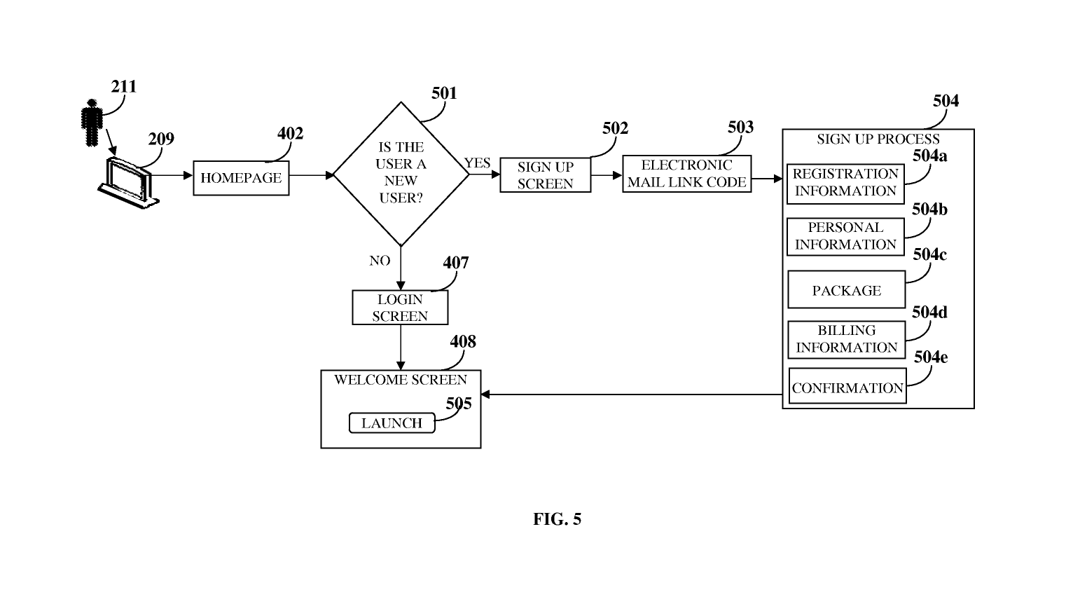

In an embodiment, a head end 206 comprises the satellite receiver array 201, application servers 205, mass storage devices, the internet datagram protocol (IDP) transcoder 203, etc. In an embodiment, the application server 205 stores additional information associated with the content data streams 207 and the content sources. In another embodiment, the application server 205 acts as a data warehouse where metric information associated with the content data streams 207 is stored and viral content, marketing information, etc., is collected. In another embodiment, the head end 206 comprises decoders such as the integrated receiver/decoders (IRDs) 303, the radio frequency (RF) transceiver 302, and the encoders 304. In an embodiment, the head end 206 can include or communicate with servers or storage of advertising content, which can be selectively provided to a particular instance of an authorized player. From the content delivery network (CDN) 208 or the broadcast nodes, the content data streams 207 are selectively sent to remote client computing devices 209 for display by an instance of a player. The player is obtained by registering with the interactive content distribution platform which then provides for subsequent login as exemplarily illustrated in FIGS. 4-5. The peer computing devices 308 access the content data streams 207 via the client computing devices 209, for example, through a real time media flow protocol.

FIG. 4 exemplarily illustrates a flow diagram showing elements of a website 401 implemented by the interactive content distribution platform for registering multiple users. A user registers with the interactive content distribution platform by establishing an account, where the account can have multiple subaccounts. For example, the account can be created by a holder of a credit card, where the account owner establishes a primary account and at least one subaccount, and in select configurations, multiple subaccounts. The account owner can determine the profile of each of the subaccounts. That is, the account owner can assign a level of content and security to each subaccount. The subaccount can be limited to certain times of access, filtering, purchasing, as well as contacts. In an embodiment, each subaccount can be classified based on a predetermined age range, or the user age can be set and the interactive content distribution platform can move the user through the age groups as the user ages. The age groups comprise, for example, 0-6, 7-13, 13-16, 16-18, and older than 18. While the primary account may be searchable on the network or the content delivery network (CDN) 208 exemplarily illustrated in FIGS. 2-3, in an embodiment, the subaccounts are protected to be invisible.

Further, if the subaccount seeks to directly communicate with a friend, for example, through video, the account owner must contact the account owner associated with the friend, where contact information is exchanged in both directions. Thus, either account can accept or reject the proffered communication. The received contact information is then provided to the interactive content distribution platform by each account owner as authorization for direct contact between the two sub accounts. All connections and content data streams 207 exemplarily illustrated in FIGS. 2-3, are audited to maintain integrity and authorization. With respect to encryption, all content data streams 207 are delivered to the player on a client computing device 209 exemplarily illustrated in FIGS. 2-3 via advanced encryption standard (AES) transmission control protocol (TCP) connections to the content delivery network (CDN) 208 or the broadcast nodes. The client, that is, the remote computing device 209, is tested for security best practices including, for example, decompiling resistance, stream capturing, and known attack vectors to protect the content data streams 207.

A user using a computing device 209 accesses a homepage 402 of the interactive content distribution platform via the graphical user interface (GUI). The interactive content distribution platform provides the user with multiple homepage options, for example, a login screen 407, an “about” section 412, registration analysis components 403, etc. The users subscribe to the interactive content distribution platform via a registration section 405 provided by the registration analysis components 403. The interactive content distribution platform comprises multiple registration analysis components 403 configured to analyze registration information associated with subscribed users. The registration analysis components 403 are, for example, a frequent code component 404, a registration demographics component 406, etc. The interactive content distribution platform maintains registration demographics via the registration demographics component 406 and manages frequent code changes via the frequent code component 404. The interactive content distribution platform provides the user with the login screen 407 for allowing the user to subscribe to or log in to the interactive content distribution platform. The interactive content distribution platform directs the user to a welcome screen 408 upon successful authentication of login information provided by the user via the GUI. The interactive content distribution platform allows the user to manage his/her user account from a user profile section 409 where the user can, for example, create, modify, delete, etc., the user account. The interactive content distribution platform allows the user to send invitations to other users from an invite friends section 410, for example, to enable them to subscribe to the interactive content distribution platform, join a group, etc. The interactive content distribution platform provides an integrated cyber environment (ICE) 411 to allow the user access the content data streams 207 using an ICE player. The ICE player is designed and created using, for example, Adobe® technology. The interactive content distribution platform uses Adobe's therapeutically relevant multiple pathways (TRMP) and TRMP streaming protocol to allow content sources or content owners, for example, studios, content owners, broadcasters, content syndicates, etc., to securely deliver the content data streams 207 from the application server 205 exemplarily illustrated in FIGS. 2-3, for example, the HTML media server to an HTML player in a web browser or to an Adobe® AIR®-based desktop application. The HTML media server and the HTML player communicate for transmission and/or reception of the content data streams 207 using the real time messaging protocol (RTMP). The interactive content distribution platform enforces the RTMP handshake between the HTML player clients and performs small web format (SWF) verification to ensure that connection requests are received from an expected source.

The “about” section 412 of the interactive content distribution platform provides information about different features supported by the interactive content distribution platform. The “about” section 412 comprises, for example, a management section 413, a media center 414, a support knowledge base 415, a contacts section 416, a partners section 417, a blog section 418, a “type of service” section 419, a privacy policy section 420, etc. The management section 413 provides information associated with management of the website 401 of the interactive content distribution platform. The media center 414 is provided as a communication platform to allow users such as journalist, bloggers, subscribers, etc., to receive and/or provide latest media related information associated with the interactive content distribution platform. The support knowledge base 415 is a repository comprising, for example, information, guidelines, and questions and answers contributed by multiple users or a support team of the interactive content distribution platform, etc., associated with the website 401 of the interactive content distribution platform. The contacts section 416 provides information about contact details of a company managing the interactive content distribution platform to allow the users to contact different management departments of the company with any technical/non-technical query associated with the website 401 of the interactive content distribution platform. The partners section 417 provides information about business partners of the company managing the interactive content distribution platform. The blog section 418 provides multiple blogs, articles, posts, etc., provided by registered and non-registered users on the website 401 of the interactive content distribution platform. The “type of service” section 419 provides information about different types of subscription schemes a user can select to register with the interactive content distribution platform. The privacy policy section 420 provides information about a privacy agreement or a legal document that comprises terms and conditions for using the website 401 of the interactive content distribution platform, and information about how the interactive content distribution platform manages, shares, and/or stores, for example, user information, the content data streams 207, information associated with the content data streams 207, information associated with the content sources, etc.

FIG. 5 exemplarily illustrates a flow chart of a login mechanism to the interactive content distribution platform implemented as a website 401 exemplarily illustrated in FIG. 4. A user 211 using a computing device 209, for example, a smart phone, accesses a home page 402 on the graphical user interface (GUI) of the interactive content distribution platform to login to the interactive content distribution platform. The interactive content distribution platform prompts the user 211 to specify whether 501 the user 211 is a new user or a registered user. If the user 211 is not registered with the interactive content distribution platform, the user 211 may sign up to the interactive content distribution platform via a sign up screen 502 provided by the interactive content distribution platform by providing, for example, an electronic mail (email) link code 503, via the GUI of the interactive content distribution platform. The interactive content distribution platform then guides the user 211 through a sign up process 504 where the user 211 is prompted to provide information associated with the user account, for example, registration information 504a, personal information 504b, choice of a package 504c, billing information 504d, a confirmation 504e for the registration, etc. If the user 211 is a registered user, the user 211 can enter his/her login credentials in the login screen 407 via the GUI. The interactive content distribution platform then directs the user 211 to the welcome screen 408. The user 211 can access any content data source provided by the interactive content distribution platform via the content delivery network 208 exemplarily illustrated in FIGS. 2-3, through the launch section 505 after successful login to the interactive content distribution platform.

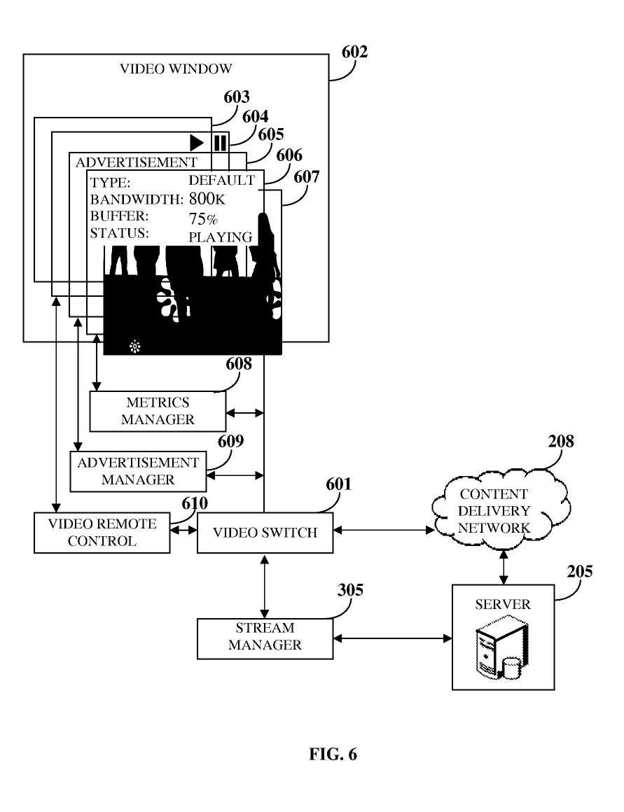

FIG. 6 exemplarily illustrates a flow diagram of a process for operation of a video canvas within a player 607 for presenting and viewing a content data stream 207 exemplarily illustrated in FIGS. 2-3. In an embodiment, security and quality analysis of the content data stream 207 can be performed automatically as well as actively using commercially available software programs. For example, connections and activity are monitored actively and automatically via commercially available firewalls and intrusion detection computer programs. Moreover, client sampling can be employed to monitor and identify aberrant usage patterns. Encoding and transmission of content data streams 207 are automatically restarted and configured in the event of content degradation. All instances of the player 607 at a client location, the transmission of the content data streams 207, operation of the content delivery network (CDN) 208, and data interactions between one or more computing devices 209 exemplarily illustrated in FIGS. 2-3 and the interactive content distribution platform provide monitoring and inspection points to maintain content integrity as well as provide forensic analysis of delivery of the content data streams 207.

The stream manager 305 of the authenticated player 607 requests a content data stream 207 from the content delivery network (CDN) 208 or a broadcast node. The requested content data stream 207 is then passed from the CDN 208 or the broadcast node to the stream manager 305, which in turn passes the signal to a video switch 601. The video switch 601 then passes the content data stream 207 to a video canvas in the player 607, and is thus viewable or audible on the associated display screen 209a exemplarily illustrated in FIG. 2. A metrics manager 608 receives the metrics from the video canvas, and provides the metrics or data corresponding to the metrics to the broadcast node or the CDN 208. The broadcast node or the CDN 208 then adjusts or alters the content data stream 207 and passes the content data stream 207 to the stream manager 305. The player 607, for example, a video player is a single player for providing multiple video, audio and interactive functions, security, and monitoring. As a single player 607 is employed, the same codebase can be used for each of the video, audio and interactive functions, the security, and the monitoring. The player 607 includes the video canvas and provides for integration testing isolation and content data stream integrity. The player 607 is automatically installed on the user's computing device 209, via an installer such as an HTML Installer or via the AppStore for the iPhone® upon login or authenticated access to a user account registered with the interactive content distribution platform. Thus, the player 607 decodes the encrypted content data stream 207 in accordance with the commercially available configuration. As set forth below, in the Adobe® suite, the decryption keys are a component of the ActionScript® virtual machine (AVM) of Adobe Systems Incorporated, and are selected to not to be revealed in any currently known small web format (SWF) decompiling process.

As exemplarily illustrated in FIG. 6, the player 607 includes a video window 602; a video scrim 603, a video window controls 604, a video advertisement overlay 605, a video metrics overlay 606, and a video player 607 accessible via a browser. The video window 602 is integrated into the graphical user interface (GUI) of the remote computing device 209 or the client using a video window class:

```
<media:VideoWindow
      Id=”mywindow”
      Width=”800”
      Height=”450”
      VideoAlign=”center”
      playerType=”vod”
      showMetrics=”true”
      showControls=”false”
      windowControls=”VideoWindowsControls_Instance”
      streamToken=”gemTestStream1”
      clientToken=”gemTestClient”/>
```

The tag above creates an instance of the video window 602 in the metrics manager 608, an advertisement manager 609, the stream manager 305, and the video switch 601. This set of instances constitutes a unique stream path, of which there can be any number of content data streams 207 in the client computing device 209 at any given time, for example, via video content or picture-in-picture (PIP). The properties of the video window class are: (a) “VideoAlign” which specifies if the width and height do not correspond to the video aspect ratio or is scaled smaller than its normal size, then the video can be aligned left, center or right; (b) “playerType” which employs default live and video on demand (VOD) streams in the main window. A playerType “preview” optimizes the player 607 for viewing a preview of the streaming content data stream 207, such as roll over in a schedule grid. A playerType “chat” configures the player 607 for a video chat. To view any PIP stream and an outgoing chat stream, the playerType “preview” video is used; (c) “showMetrics” which makes the player diagnostics overlay visible; (d) “showControls” which shows or hides the inline player controls; (e) “windowControls” which passes an instance of a video window class that extends the video window controls 604 to provide customized inline video controls; (f) “streamToken” which is a reference to a content data stream 207 to play, where no content data stream names are passed to the client player 607 until after authorization of the client computing device 209 and the content data stream request; (g) “clientToken” which is a unique session reference passed to the client computing device 209 on startup, which is used for authorization in the stream manager 305; (h) an “autoPlay” which specifies if the content data stream 207 will play automatically once the content data stream 207 is available.

An additional video window class allows embedding of a video remote control 610 anywhere in the GUI. Methods, for example, play, pause, resume, seek, etc., can be called which control transport of the content data stream 207 for a particular instance and events, for example, net stream events, metrics events, advertisement events, etc., are fired from the stream path:

<media:VideoPlayerRemote
streamPath=”{mywindow.streamPath}/>”

The properties of the “VideoPlayerRemote” video window class include “streamPath” which specifies a unique stream path, for example, a unique identifier for a particular live content data stream 207, a chat session during streaming of VOD content, etc., to be controlled by the video remote 610. Several dynamic elements are controlled by the metadata associated with the content data stream 207 simultaneously, such as video, including a video scrim overlay, as a large icon or a scrim 603, that covers the entire video window 602 during a video stop state; static image which provides an image displayed beneath the video scrim 603, if any, but over and above all other video window components during a stop state; and the video advertisement overlay 605 which is triggered during net stream advertisement events. The advertisement manager 609 manages the simultaneous streaming and display of advertisements.

The player 607 further monitors the volume of the content data streams 207 simultaneously at the client computing device 209 and allocates available resources including transmission rates and processing capacity. That is, each instance of the player 607 and hence the video canvas is interdependent and the utilization requirements of each player instance is a function of the remaining instances of the video canvas. The player 607 also permits the client computing device 209 to initiate PIP viewing of multiple content data streams 207 simultaneously, each within a corresponding video canvas. In an embodiment, the audio associated with the PIP is muted until the user using the client computing device 209 selects the PIP as the main video canvas. In an embodiment, the audio associated with a particular video canvas can be automatically enabled and disabled in response to a position of a cursor on the display screen 209a. As the interactive content distribution platform monitors the location of the cursor or another input device and the location of one or more of the video canvases, the interactive content distribution platform employs the position of the cursor to cause an associated audio data to be audible, without requiring any clicking by the user. Thus, by moving the cursor to overlay a given video canvas, the player 607 can automatically initiate a sufficient volume, while terminating the audio of the vacated video canvas.

The video canvas is therefore distinct from the windows of prior commercially available GUIs. The video canvases disclosed herein are under the control of a single player 607, where the content data stream 207 of one video canvas is dependent upon the content data stream 207 being presented at a second video canvas. Thus, the display of a content data stream 207 in one video canvas is adaptive to the display of a second content data stream 207 in a second video canvas simultaneously on the same display screen 209a. Furthermore, the video canvas can present content data streams 207 of different content formats including different encoding formats simultaneously.

The player 607 is constructed in a multimedia authoring program for viewing animations and movies simultaneously using common commercially available computer programs such as a web browser. Available web browsers comprise, for example, Windows® Internet Explorer® of Microsoft Corporation, Mozilla® Firefox® of the Mozilla Foundation, Apple Safari® of Apple Inc., Google® Chrome, and Opera of Opera Software ASA Corporation. Thus, the player 607 runs within the browser on the client computing device 209, as a browser window.

An example of a multimedia authoring program is the Adobe® Flash® player or the Flash® player. The Flash® player is a widely distributed proprietary multimedia and application player created by Macromedia and currently developed and distributed by Adobe Systems Incorporated. The Flash® player runs small web format (SWF) or shockwave or standard exchange format (SEF) files that can be created by the Adobe® Flash® authoring tool, by Adobe® Flex®, or by a number of other Macromedia and third party tools. Adobe® Flash® often refers to both the multimedia authoring program and the Adobe® Flash® player, which uses vector and raster graphics, a native scripting language called ActionScript®, and bidirectional streaming of video and audio. Adobe® Flash® is the authoring environment and the Adobe® Flash® player is the virtual machine used to run the Adobe® Flash® files. It is understood that in industry literature, the term “Flash” can mean either the authoring environment, the player 607, or the application files. It is further understood that all references to Adobe® Flash® include any future modifications/additions to Flash® and also HTML programming. The Adobe® Flash® player is available as a plug-in for recent versions of numerous web browsers, for example, Mozilla® Firefox®, Opera, Safari®, and Internet Explorer® on selected platforms. Moreover, the Adobe® Flash® is compatible with multiple mobile operating systems. Adobe® has developed and updated multiple softwares to allow the content data streams 207 to be transmitted to computing devices 209, for example, televisions (TVs), tablets, smart phones, and any other digital device. Hence, Adobe® Flash® represents only one of the many Adobe® software that the interactive content distribution platform implements. Another example of a multimedia authoring program is HTML5 for creating mobile interactive features, animation, and other animated interactive content.

For purposes of illustration, the detailed description refers to Adobe® Flash® as a multimedia authoring program; however, the scope of the computer implemented method and system 200 disclosed herein exemplarily illustrated in FIGS. 2-3 and FIG. 10, is not limited to the use of Adobe® Flash® but may be extended to include a hypertext markup language (HTML), HTML5, and other Adobe® software of Adobe Systems Incorporated, for example, Adobe® Flex®, Adobe® AIR®, Adobe® Cold Fusion, Adobe® Photoshop® Touch, Adobe® Collage, Adobe® Debut, Adobe® Ideas, Adobe® Kuler®, Adobe® Proto, Adobe® Edge, etc. Thus, Adobe® Flash® has been updated by Adobe Systems Incorporated to new technologies that allow, for example, up to 30 live streams of content to be streamed onto digital devices such as TVs, tablets, smart phones, etc.

In an embodiment, from an edge node of the content delivery network (CDN) 208 to the client computing device 209, the content data streams 207 are delivered simultaneously directly to a software client using the application server 205, for example, the HTML media server. Another multimedia authoring program for the player 607 is QuickTime® developed by Apple Inc. QuickTime® is capable of handling various formats of digital video, media clips, sound, text, animation, music, and interactive panoramic images. The QuickTime® streaming server has been found satisfactory for streaming content data streams 207 in the QuickTime format. The player 607 is configured to deliver multiple content data streams 207 simultaneously to the display screen 209a connected to the authenticated client computing device 209, for example, a computer, a tablet, a smart phone, a TV, etc.

As the user input passes through the website 401 exemplarily illustrated in FIG. 4 of the interactive content distribution platform, all user interactions can be monitored and recorded, for example, by keystroke or key logging, as well as screen logging. Thus, each action of the user with respect to the website 401 and hence associated content data streams 207 can be measured simultaneously. The user actions measured by the interactive content distribution platform comprise, for example, initiation and abandonment or termination of viewing the content data streams 207; pausing and resuming viewing of the content data streams 207, etc. This monitoring can be used to provide dynamic or active filtering. As specific sites are restricted by individual users, the interactive content distribution platform monitors such restrictions of the associated website and can automatically add the website to a different class or restricted group. As the geolocation allows the interactive content distribution platform to know the location of each client computing device 209, the interactive content distribution platform tailors the classification of websites simultaneously as a function of other users as well as geographic location. For example, what is not restricted in New York City, may be restricted in Saudi Arabia. The dynamic filtering can be uniquely applied to different subaccounts of a given user. In an embodiment, the account may have multiple subaccounts, wherein each of the subaccounts is associated with a specific user or an age range. The interactive content distribution platform can then restrict certain websites for selected ages and hence subaccounts, thereby allowing different subaccounts to view different content data streams 207 or websites.

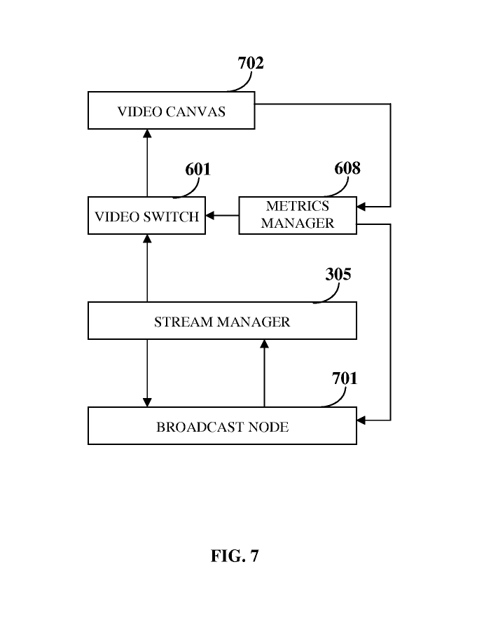

FIG. 7 exemplarily illustrates a flow diagram for monitoring transmission and user metrics for controlling at least the quality of a content data stream 207, exemplarily illustrated in FIGS. 2-3. Referring to FIG. 7, quality of service or available transmission rate is actively monitored by real time metrics from each client computing device 209 exemplarily illustrated in FIGS. 2-3. Content data streams 207 are rerouted and additional streaming servers are deployed simultaneously in response to demand according to network conditions. The content data streams 207 can be rerouted topologically to the nearest access as well as across the content delivery network (CDN) 208 exemplarily illustrated in FIGS. 2-3 and FIG. 6 to avoid network congestion. That is, the CDN 208 and/or the broadcast node 701 are continuously load balanced.

In an embodiment, the user created content can be shared simultaneously through the interactive content distribution platform. For such content, the user uploads the user created content, which is passed through the encoders 304 exemplarily illustrated in FIG. 3, and thus labeled and disseminated as other content data streams 207. However, in an embodiment, at least some user created content data may be encoded by the authenticated instance of the player 607 exemplarily illustrated in FIG. 6, and the content data stream 207 then passes from the originating instance of the player 607 to the CDN 208, and then to the interactive content distribution platform storage mechanism or databases for archival. In certain instances of the player 607, the content data stream 207 to be encoded is passed through a built-in codec, for example, the Sorenson® codec of Sorenson Media Inc. However, depending on load balancing, it is understood that if excess demands were placed on the instance of the player 607, the content data stream 207 can be passed to a broadcast node 701 or the encoders 304 at the head end 206 exemplarily illustrated in FIGS. 2-3. That is, as the interactive content distribution platform actively monitors loads, transmission rates, and user activity, the interactive content distribution platform reacts to changing demands. The broadcast node 701 transmits the content data stream 207 to the stream manager 305. The stream manager 305 transmits the content data stream 207 to the video switch 601 that transmits the content data stream 207 to a video canvas 702 on the user's computing device 209. The metrics manager 608 receives metrics information of the content data streams 207 from the video canvas 702 and transmits the metrics information to the video switch 601 and the broadcast node 701. The metrics manager 608 is associated with the metric overlay 606 on the video window 602.

In select configurations, the interactive content distribution platform passes the content data streams 207 simultaneously through the encoders 304. Thus, depending on the demand for a picture-in-picture (PIP) feed from a user's client computing device 209, the content data stream 207 is passed through the encoder 304 and then is passed to the terminal end. The user generated PIP can thus be provided to a viewing circle simultaneously in either a private or public viewing. Further, passage through the encoder 304 allows separate encryption of the content data stream 207 that is the PIP. With respect to social networking, a micro-blogging service, and a short message service (SMS), these inputs remain in the native content format, but are wrapped in a digital container or wrapper and can thus be tracked as with the associated video canvas 702. That is, some of the content data streams 207 are digitally wrapped in the player 607. That is, in those configurations employing Adobe® Flash®, selected content data streams 207, such as the text of Twitter® or Facebook®, are maintained in the originating content format and Flash® is used to provide the special file format metadata for the storage and transport of the wrapped content data stream 207, with each of the steps performed simultaneously. Adobe® Flash® and hypertext markup language (HTML) are thus used to provide the file format or stream format which specifies the way the wrapped content data streams 207 are stored, but not coded, within the file and the available metadata. In these configurations, Adobe® Flash® wraps the content data streams 207 by storing the actual content data streams 207 and the information about how the content data streams 207 are stored within the file. Thus, the instance of the player 607 can treat the wrapped content data stream 207, for example, as a Flash® encoded content data stream 207.

By disposing content data streams 207, whether streaming or merely as a document, through the encoders 304 and thus creating a common content independent format, the interactive content distribution platform allows a user to select a content data stream 207, whether third party or self-generated or video, audio or text, to be shared to a predetermined affinity group, criteria meeting third parties, all third parties, or restricted invitations. With respect to self-produced or a user created content data stream 207 using a client computing device 209, such content data streams 207 are passed through the encoders 304 and are thus treated as incoming third party commercial content data streams 207, thereby having associated metadata, transmission control, encryption, and authentication performed simultaneously. Further, as such the user created content data streams 207 are monitored by the interactive content distribution platform, the interactive content distribution platform tracks viewing and associates relatively new user created content data streams 207 with an existing commercial entity allowing for sponsorship, advertising, or product placement opportunities for both parties.

FIG. 8 exemplarily illustrates a flow diagram for obfuscating content data stream names. The interactive content distribution platform further enables the obfuscation of content data stream names on the content delivery network (CDN) 208 and the ability to store and retrieve metrics on the content data streams 207 exemplarily illustrated in FIGS. 2-3. Referring to FIG. 8, the obfuscation of content data stream names on the CDN 208 is accomplished by a token authorization model involving an open source web application framework for the Ruby programming language, for example, the Ruby on Rails® system 309 on a back end, and a software development framework for the deployment of cross platform rich internet applications based on the Adobe® platform such as Adobe® Flex®, Adobe® AIR®, Adobe® Cold Fusion, and the hypertext markup language (HTML). Specifically, when the content data streams 207 originate from the encoders 304, the content data streams 207 are broadcast to the application server 205, which in turn publishes the content data streams 207 to the CDN 208. As the content data streams 207 are published to the CDN 208, the application server 205 communicates the names and the locations of the content data streams 207 to the Ruby on Rails® system 309. The Ruby on Rails® system 309 stores each content data stream name and generates a random string such as a universally unique identifier (UUID) which is used as a public content data stream name. The Ruby on Rails® system 309 also associates the content data stream 207 with program guide data, for example, by using the content data stream location and a current time to associate each content data stream 207 with a channel. As set forth in the description of the variable bit content data stream component, there can be multiple content data streams 207 associated with each program item, that is, multiple bandwidths and recorded digital video recorder (DVR) streams. Once the Ruby on Rails® system 309 has returned a new name for each content data stream 207, the application server 205 then publishes each content data stream 207 to the CDN 208.

Authorization of the client computing device 209 and an instance of the player 607 exemplarily illustrated in FIG. 6, is provided by passing a program guide key or a token to the player 607. The player 607 then passes the token along with a client token unique to the user's client computing device 209 to the Ruby on Rails® system 309. The unique client token may be a string to be delivered to the client computing device 209 from a user management system. Upon completion of this passing, the Ruby on Rails® system 309 sends the player 607 a list of content data streams 207 associated with the requested program. In an embodiment, the token, for example, the stream token, the client token, etc., can be a number used once (nonce), where the nonce can be a random or pseudorandom number issued in an authentication protocol to ensure that old communications cannot be reused in replay attacks. For example, the nonces are different each time an authentication challenge response code is presented, and each client request from the authenticated instance of the player 607 has a unique sequence number, thereby making replay attacks and dictionary attacks exceptionally difficult. Thus, content data stream requests must be validated using a one-time token sent and audited separately prior to the start of transmission of the content data stream 207. The client computing devices 209 are precluded from connecting to a content data stream 207 unless a one-time token sent and audited separately is provided. A content data stream inventory is provided by a reference stored in the Ruby on Rails® system 309. The content data streams 207 generated in the technology stack, for example, the encoders 304, origin, video chat, etc., have a reference, even if the content data streams 207 are not publically available.

Metrics associated with the content data stream 207 are stored in an extensible markup language (XML) format for a predetermined period of time, for example, between about 12 hours to about 24 hours in one or more databases of the interactive content distribution platform. For each content data stream 207, a set of non-specific individual identifying metrics is stored for the predetermined time. That is, the stored metrics do not identify the specific user, but rather are representative of demographics of the user such as statistics characterizing human populations or segments of human populations broken down by age, sex, income, etc. Each metrics datum is time stamped so that the metrics can be reconstructed using an Adobe® Flex® client. The communication between the Adobe® Flex® client and the Ruby on Rails® system 309 is provided in an action message format (AMF). For example, the data used as a stub for retrieval of a content data stream location, is provided by a request from the user for a particular program data item.

```
<location name=”rickRoll” type=”vod”>
        <connection>
            <application>vod</application>
            <ip>192.168.1.1</ip>
        <connection>
        <stream>
            <name>Never Gonna Give You Up</name>
            <type>vod</type>
            <uid>anlHk77#ks\hat{ }kssaap</uid>
            <url>astley_never_gonna_1200k</url>
            <videobitrate>1200</videobitrate>
            <audiobitrate>96</audiobitrate> <events>
                <event>
        <type>com.gigaentertainmentmedia.events.-
        ClosedCaptioningEvent</type>
                </event>
                <event>
                    <type>com.gigaentertainmentmedia.events.-
                    AdEvent</type>
            </event>
        </events>
        </stream>
        <stream>
            <name>Never Gonna Give You Up</name>
            <type>vod</type>
            <uid>dioNmsomKk6KkM00akw</uid>
            <url>astley_never_gonna_800k</url>
            <vodepbotrate>800</videobitrate>
            <audiobitrate>96</audiobitrate> <events>
                <event>
        <type>com.gigaentertainmentmedia.events.-
        ClosedCaptioningEvent</type>
                </event>
                <event>
                    <type>com.gigaentertainmentmedia.events.-
                    AdEvent</type>
                </event>
            </events>
        </stream>
        <stream>
            <name>Never Gonna Give You Up</name>
            <type>vod</type>
            <uid>oosmaii833kMMlw92&m</uid>
            <url>astley_never_gonna_400k</url>
            <videobitrate>400</videobitrate>
            <audiobitrate>48</audiobitrate>
            <events>
        <type>com.gigaentertainmentmedia.events.-
        ClosedCaptioningEvent</type>
                </event>
                <event>
                    <type>com.gigaentertainmentmedia.events.-
                    AdEvent</type>
                    </event>
                </events>
        </stream>
</location>
```

When metrics data is received, the metrics data has an arbitrary structure due to heterogeneous content data stream types, for example, video on demand (VOD), subscription video on demand (SVOD), video, chat, data, etc. An illustrative example is:

```
<metrics streamType=”vod”>
      <uid>ggYx5rrd</uid>
      <metric>
          <name>ave_buffer_pct</name>
          <value>67</value>
      </metric>
      <metric>
          <name>num_insufficient_bw</name>
          <value>0</value>
      </metric>
</metrics>
```

A single internet protocol (IP) network connection is supported per player 607 instance at the client location. Using geolocation information, the client computing device 209 can be selectively prevented from receiving selected content data streams 207 as a function of the internet access point. The player 607 is configured to be renewed, where security renewal does not require permission of the client computing device 209. Renewal is initiated by setting an invalidity flag in the player 607. The invalidity flag causes the player 607 to automatically renew by loading the appropriate version from a website 401 of the interactive content distribution platform exemplarily illustrated in FIG. 4. However, the player 607 can be revoked by rendering the player 607 non-functional. In an embodiment, the player 607 loads from a secure location with a one-time use token. Upon initialization, the token is returned to a security server to authorize the player 607 to connect to the website 401 or the content delivery network 208. Upon connection to the website 401, the network 208, or the application server 205, the player 607 must pass the token for each content data stream 207 along with a one-time use token received from the security server prior to receiving each content data stream 207. The receipt of each single use token is predicated on validation of user credentials and user content permissions as can be set by an account administrator.

The variable bit stream technology allows the content data stream 207 to be encoded in one of multiple predetermined transmission rates. For example, the encoders 304 provide the content data stream 207 at any one of 400 kilobits per second (kbps), 800 kbps, 1.0 megabits per second (Mbps), and 1.2 Mbps. As there is an active link between the content delivery network (CDN) 208 and the client computing device 209 by virtue of the instance of the player 607 running on the client computing device 209, the available transmission rate is continuously or at least perceived as continuously, monitored. Thus, if the encoder 304 is providing the content data stream 207 at 800 kbps and the available transmission rate drops to 700 kbps, the variable bit stream program adjusts the transmitted content data stream 207 to the available transmission rate, by transcoding the encoder provided 800 kbps content data stream 207 to the available 700 kbps transmission rate. The variable bit stream program continues to transcode the content data stream 207 between the available predetermined rates from the encoder 304 as a function of the available transmission rate matching one of the predetermined encoder rates. The variable bit stream technology requests the nearer predetermined rate from the encoder 304 and passes the rate to the client computing device 209, that is, the authenticated instance of the player 607. As applied to a broadcast node 701 exemplarily illustrated in FIG. 7, the variable bit stream program allows the software to bridge the gaps between the available transmission rates for the content data stream 207 as provided by the encoders 304.

In an embodiment, the application server 205 provides dynamic streaming to automatically detect and switch among different bit rates, thereby allowing remote client computing devices 209 to view content data streams 207 simultaneously without pauses or interruptions. Further, in an embodiment, the interactive content distribution platform monitors all content data streams 207 to detect and isolate faults. Further, the interactive content distribution platform captures the parameters and events from client computing devices 209 to broadcast flag streams. Encryption can include industry standard real time messaging protocol encrypted (RTMPE), wherein the real time messaging protocol (RTMP) can be encapsulated within hypertext transfer protocol (HTTP) requests to traverse firewalls, or RTMPS which is an RTMP over a transport layer security (TLS)/secure sockets layer (SSL) connection, which operates over a secure hypertext transfer protocol secure (HTTPS) connection. Further, for the application server 205, small web format (SWF) verification can be employed in addition to the RTMPE.

Furthermore, the interactive content distribution platform contemplates the use of one or single use tokens, wherein upon authentication with the interactive content distribution platform, a first single use token is passed to the authenticated instance of the player 607. When the user requests a content data stream 207, the first single use token is passed from the player 607 to the application server 205, and a second single use token is passed to the player 607 with the content data stream 207, at which time the token is no longer valid. When the player 607 requests a second content data stream 207, the second single use token is passed to the application server 205 and a third single use token is passed to the player 607 with the second requested content data stream 207. Each time a token is passed, the interactive content distribution platform authenticates the request against multiple factors, for example, billing or accounting, a subscription level, applicable filters including content filters, viewing circles, events and blackouts, geographic restrictions, etc. Currently, the exchange of single use tokens and authentications requires, for example, approximately 3 seconds or less.

Since a single use token is only valid once for the associated content data stream 207, if the token is twice presented to the application server 205, the interactive content distribution platform recognizes the attempt and can implement any of a variety of responses, for example, deactivation or invitation to resend. The use of the single use tokens can also be applied to other devices registered within a given account. For example, if the user has registered an iPhone® device with the interactive content distribution platform, an authenticated instance of the player 607 can be initiated on the iPhone® device. A request can then be made from the iPhone® device and the associated single use token and the content data stream 207 are transmitted to the iPhone® device. Authentication including authentication with the service provider of the iPhone® device can occur with each token exchange, again checking system parameters as well as parameters with the iPhone® service provider.

As the iPhone® device has a global positioning system (GPS) capability, and the interactive content distribution platform actively tracks each connection, the interactive content distribution platform can monitor the location of the iPhone® device relative to the geographic location of the computing device 209 of an account holder which is known as set forth below. Thus, if the interactive content distribution platform detects the iPhone® device having traveled greater than a predetermined separation from the geographic location of the computing device 209 of the account holder, the interactive content distribution platform can terminate communication with one of the devices, typically the stationary device.

Further, the interactive content distribution platform can be configured such that upon initiating viewing of a content data stream 207 on the iPhone® device, the transmission to the stationary instance of the player 607 exemplarily illustrated in FIG. 6, is terminated within a predetermined time. Furthermore, as the iPhone® device is a registered device with the interactive content distribution platform, the iPhone® device can run a video remote control application to function as a video remote control 610 of the authenticated instance of the player 607, or the iPhone® device can function as a camera, for example, a video camera providing the content data stream 207 to the authenticated instance of the player 607. It is understood that the iPhone® device runs programming to provide cursor control functions as a computer mouse or an input device on a secondary separate authenticated computing device 209. That is, the commands, for example, cursor control or keyboard input, generated by the iPhone® device are transmitted to the secondary device, and as the interactive content distribution platform monitors the location of the displayed content data stream 207 on the respective display screen 209a exemplarily illustrated in FIG. 2, the commands from the iPhone® device can control and modify the display on the remote display screen 209a of a separate authenticated instance of the player 607. The content data stream 207 can be provided to the iPhone® device by HTTP streaming.

Geolocation allows a given user to be limited to a specific network or geographic area, for example, by zone improvement plan (ZIP) codes, or alternatively stated access can be denied based on the same parameters. Geolocation is the process of automatically identifying a physical location of a client computing device 209 without the user having to provide any information, for example, a ZIP code. Geolocation is available for virtually all web browsers and does not require any plug-ins or cookies. Geolocation employs a mapping of internet protocol (IP) addresses to a specific location. Additional data used in the geolocation includes cell tower usage and Wi-Fi® access points. Satisfactory geolocation data is provided, for example, by Quova, Inc. Thus, the IP address known by the interactive content distribution platform can be used to provide information such as country, region, city, postal/zip code, latitude, longitude, and time zone for the given IP address, and hence for the user. Thus, the interactive content distribution platform either acquires or accesses a database providing the location, wherein location comprises, for example, country, region, city, postal/ZIP code, latitude, longitude, or a time zone of a given user, and can implement necessary blackouts of content data stream restrictions related to a geographic location. This geographic data is stored in one or more databases of the interactive content distribution platform or accessed by the interactive content distribution platform and is used with advertising, for example, the video advertisement overlays 605 exemplarily illustrated in FIG. 6, and compliance with content data stream licenses.

Initiation of the advertisement overlay, for example, the video advertisement overlay 605 can be set to any number of triggers. For example, the video advertisement overlay 605 can be initiated at predetermined intervals along a content data stream 207. Alternatively, the video advertisement overlay 605 can be initiated at predetermined times, independent of the timing of any content data stream 207 in the video canvas 702 exemplarily illustrated in FIG. 7. It is understood that the video advertisement overlay 605 can be initiated in response to metadata associated with the given content data stream 207. That is, in the received content data streams 207 at the integrated receiver/decoder (IRD) 303 exemplarily illustrated in FIG. 3, the content data streams 207 may include metadata, for example, a title, a director, actors, summary of the content, length of the recording, critical rating, and the data and source of the recording, as well as a file name and a current status such as a viewing status, a “save until” date, etc. Thus, the video advertisement overlay 605 can be initiated in response to a particular type or content of metadata.

Further, the content of the video advertisement overlay 605 can similarly be provided corresponding to the subject matter of the metadata. Thus, content data streams 207 of romantic comedies initiate different video advertisement overlays 605 than playoff football games. In an embodiment, the interactive content distribution platform, typically at the encoding step, can associate additional metadata with the content data stream 207, thereby providing for more specific tailoring of the video advertisement overlay timing and content. For example, a product placement can be noted at a particular time in the content data stream 207, such that the video advertisement overlay 605 for the product or related product appears simultaneously or substantially simultaneously with product placement in the content data stream 207.

Furthermore, the interactive content distribution platform monitors the input from the user through the website 401 exemplarily illustrated in FIG. 4. Specifically, keystroke logging, and mouse position and input are monitored. Therefore, the interactive content distribution platform can associate particular websites visited and actions taken. This information can be collected with respect to the particular user's client computing device 209 and a common geographic or a demographic interest. This accumulated usage data can also be used to time and associate video advertisement overlays 605 with a given content data stream 207. Therefore, the initiation and the content data stream 207 for the video advertisement overlay 605 can be a function of the geographic location of the user, the profile of the user, the metadata associated with the prior content data stream 207 as well as the viewing history of the user. The content data stream 207 to be provided in the initiated video advertisement overlay 605 is stored in system application servers 205 or storage databases accessible by the system application servers 205 or the content delivery network (CDN) 208. The content data stream 207 for the video advertisement overlay 605 can provide a real time transaction through the CDN 208, for example, the internet, by allowing the client computing device 209 to save or print a coupon or an advertisement, or a link to a particular third party website.

As an example of the real time transaction, the initiated video advertisement overlay 605 can provide for a complete transaction without interrupting the prior, and now simultaneously displayed, primary content data stream 207. If the video advertisement overlay 605 is for a local pizza provider, the video advertisement overlay 605 allows communication to the network 208, for example, the internet so that the user using the client computing device 209 can size the video advertisement overlay 605 as desired, select an offered food, order the food, receive confirmation, and close the video advertisement overlay 605, without requiring the user to change any aspect of the viewing of the primary content data stream 207, or triggering of the content data stream 207. It is understood that the interactive content distribution platform monitors the content data streams 207 to the client player 607 and the available transmissions, and maintains the continuous display of the respective content data streams 207 at the respective display screen 209a associated with the player 607.

In an embodiment, the interactive content distribution platform can provide data from a program guide 310 as exemplarily illustrated in FIG. 3, for identifying content data streams 207 such as television (TV) shows for viewing. The interactive content distribution platform can stream a multitude of TV shows simultaneously. The program guide data can be obtained from a third party provider, for example, Macrovision Corporation, wherein the program guide data is displayed in a video canvas 702 in a conventional grip format. From monitoring data of the client computing device 209 and the subscriber population, the interactive content distribution platform can automatically identify items that are most popular, overall and within a genre, provide view ratings, show content data streams 207 viewed by friends or by a viewing circle, perform advanced searching, for example, for an actor, a director, time, a broadcaster, etc., as well as suggested items based on viewing habits and friend connections. Metadata from content data providers can also be included in the displayed grid. In an embodiment, video on demand is also listed, for example, by a title, a genre, a provider, etc.

Furthermore, as the interactive content distribution platform monitors cursor location and location of each content data stream 207 on the respective display screen 209a and the location of data within the content data stream 207, upon display of the program guide data, the interactive content distribution platform can be configured to enable a user to select a given term in the program guide data and automatically initiate a search on the selected data. The particular search engine and locations for searching can be predetermined by the user or the account owner. For example, if the program guide data has an entry of a movie and lists the main actors, the user can select the name of the main actor, and the interactive content distribution platform automatically conducts a search using the user defined search engine to locate additional information about the actor. Thus, the interactive content distribution platform provides live streaming content data streams 207, for example, cable or satellite TV broadcasts across a network, for example, the internet to any streaming device, wherein the streaming content data stream 207 can be integrated with social media, for example, from Twitter® or Facebook®. The interactive content distribution platform allows the viewing circles to integrate streaming content data streams 207 such as a TV with online social media and social networks, wherein the streaming content data streams 207 are commonly experienced in real time at remotely located instances of the player 607. Thus, the interactive content distribution platform provides access to and enables viewing of licensed live cable TV, social networking, interactive video, video on demand (VOD), home automation, augmented reality, voice recognition, subscription video on demand (SVOD), user generated content including video, text and audio chat simultaneously in a single website 401 of the interactive content distribution platform by virtue of a player instance within the browser of the user's computing device 209.

In the viewing circles, multiple viewers can share a synchronized or non-synchronized content data stream 207, and invite others to join, subject to individual subscriptions or authorization, to a particular content data stream 207. In an embodiment, the viewers within a viewing circle can share remote functionality of the presently described digital video recorder (DVR) controls with a predictive synchronization that maintains timing across multiple client computing devices 209. As the interactive content distribution platform controls the transmission rate of the delivery of each content data stream 207 to each member of the viewing circle, substantially simultaneous delivery of the content data stream 207 can be achieved by transmitting at the slowest transmission rate within the viewing circle. Furthermore, since each member of the viewing circle is an authenticated account or subaccount and the transmissions to the members are synchronized, the remote control of the content data stream 207 can be transferred to any member of the viewing circle.

The interactive content distribution platform allows viewers to view live streaming content data streams 207, wherein the variable bit stream provides for consistent live presentation of the content data stream 207, as the actual available transmission rate, as a function of bandwidth and network traffic, dictates the actual transmission rate of the content data stream 207 to the respective player instances.

In view of the provided encryption, access to the content data stream 207 is prevented to any other device or program. Other than the short term buffer, as set forth above three seconds or less, the content data stream 207 is stored at the remote computing device 209 at any time. Moreover, as each content data stream 207 is authorized on a per account or per device basis, access to the content data stream 207 is controlled. In an embodiment, access to each content data stream 207 is linked to a single token or nonce, authorized for the unique access. Multiple accesses are checked and rejected prior to any access attempt during the content data stream look up process. The encryption and authentication of the instance of the player 607 are selected to substantially inhibit, with the objective of precluding, recording of a content data stream 207. Thus, no material amount of the content data stream 207 is cached, other than buffered transient data, to provide for broadcast flag compliance.

The interactive content distribution platform also provides for digital video recording of the content data streams 207, independent of whether the content data stream 207 was actually viewed by the user through the client computing device 209 as a live content data stream 207. The interactive content distribution platform can record each of the available content data streams 207 within the universe of available content data streams 207. In an embodiment, the interactive content distribution platform receives, aggregates, and encodes TV programming from a wide variety of content providers, for example, the various broadcast and cable channels that produce or provide individual programs, and selectively transmits the encoded content data stream 207 to the remote location of the player instance of the individual client computing device 209. The interactive content distribution platform receives the content data stream 207 of a third party content provider, encodes, and transmits the content data stream 207 to the requesting client computing device 209 in real time. Thus, if a program of a channel, for example, Cartoon Network® of The Cartoon Network, Inc., is scheduled to air Monday night at 8 p.m., the channel transmits that program's data to the interactive content distribution platform and other cable companies nationwide at that time. The interactive content distribution platform immediately re-transmits the data to customers who subscribe to or select that channel in the website 401 of the interactive content distribution platform.

The interactive content distribution platform can include or subscribe to a remote storage digital video recorder (RS-DVR) system. The RS-DVR system allows users using client computing devices 209 to record or view recorded content data streams 207 on central hard drives of the interactive content distribution platform at a remote location. Thus, the interactive content distribution platform can automatically capture each content data stream 207 at the RS-DVR system for a given period of time, for example, 1 day, 3 days, 7 days, 14 days, 21 days, or any period as permitted by the system configuration and content licenses, wherein the user using the client computing device 209 can selectively view any of the stored content data streams 207 during the given period of time. During the given period of time, RS-DVR users may then receive playback of those content data streams 207 through the website 401 of the interactive content distribution platform to the authenticated player instance.

Under the RS-DVR system, an encoded content data stream 207 is split into two content data streams 207. The first content data stream 207 is routed immediately to the client computing device 209. The second content data stream 207 is transmitted to a number of high capacity hard disks. In an embodiment, the storage can be at the head end 206 exemplarily illustrated in FIGS. 2-3 or with the content delivery network (CDN) 208, wherein the stored content can be retained in an on-demand cache. Further, the content data streams 207 can be stored in arbitrary segments from approximately 1 minute to 30 minutes in length and reassembled in response to demand to be transmitted to the client player instance.

Using the website 401 of the interactive content distribution platform, the user using the client computing device 209 can select any recorded content data stream 207 via the graphical user interface (GUI) of the interactive content distribution platform, which is then transmitted to the client computing device 209. No actual content is stored on the client computing device 209, and the client computing device 209 does not initiate the recording. The client computing device 209 merely bookmarks or searches and accesses already stored, cached, content data at the head end 206 or the CDN 208. Depending on the agreement with the content provider, pause, rewind, and fast forward of the content data stream 207 can be selectively applied. It has been found satisfactory to limit the amount of cached content data streams 207 at the client computing device 209, for example, to approximately 180 seconds or less. The interactive content distribution platform can provide video on demand VOD, subscription video on demand (SVOD), etc., in a manner paralleling the treatment of other content data streams 207. That is, a content data stream 207 is stored in an encrypted form and transcoded on the fly for multiple bandwidth content data streams 207 or available transmission rates. In an embodiment, selected content data streams 207 can be transmitted on a rental or purchase basis, for example, via Adobe® AIR® and Adobe® Flash® digital rights management services.

The website 401 of the interactive content distribution platform is a video portal for live TV broadcasts, social networking, picture-in-picture (PIP) video, audio or text chat, interactive advertising, etc. By providing the content data streams 207 through the head end 206 and hence through the website 401, the interactive content distribution platform allows a user to view the available content from any internet access point. As each video canvas 702 is content independent, each video canvas 702 can be manipulated in previously unavailable manners. For example, the user can use a personal digital assistant (PDA), a tablet, a handheld computer, or a laptop computer to control the player instance of the website 401. Thus, the control panel can be displayed on any selected and authorized display screen 209a of the client computing device 209, thereby allowing the user to experience the interactivity from anywhere subject to blackout controls from the stored geolocation information.

As the video canvas 702 is independent of the display screen 209a on which the video canvas 702 appears, the video canvas 702 can be passed from a desktop or a stationary display screen 209a to a personal digital assistant, a tablet, a handheld computer, or a laptop computer. In application, the interactive content distribution platform monitors both keystrokes and cursor positions on the client display screen 209a. Furthermore, the interactive content distribution platform monitors which video canvas 702 or window is selected or primary. As provided in the setup or establishment of an account, specific devices are authorized with, and thus recognized by the interactive content distribution platform. Therefore, during display of a content data stream 207 on a first display screen 209a, the player 607 can provide a user identifiable transfer location on the first display screen 209a, wherein the player 607 constructs the user identifiable transfer location to represent an instruction to transfer transmission of the video canvas 702 from the first display screen 209a to a second, previously authorized, display screen 209a associated with the account. Thus, the user, by selecting a given video canvas 702 on the first display screen 209a and associating the selected video canvas 702 with the user identifiable transfer location, can cause the selected video canvas 702 with the associated content data stream 207 to cease transmission to the first display screen 209a and initiate transmission to the second display screen 209a. Thus, as each content data stream 207 is viewed through a corresponding video canvas 702, the respective video canvas 702 can be passed to a second display screen 209a of the client computing device 209, without interrupting the transmission.

The transmission rate monitoring of the interactive content distribution platform can be employed in conjunction with a virtual theater. In the virtual theater, a user, that is, a subscriber can invite specific individuals to simultaneously view at multiple remote locations a common content data stream 207, for example, a movie. In an embodiment, the invitees navigate through respective instances of the player 607 to an online ticket agent and initiate viewing at a common time. During the viewing of the common content data stream 207, the invitees can interact through a separate video canvas 702 by text, audio, or video, or any combination thereof. The interactive content distribution platform continually, as perceived by each invitee, monitors the available transmission speed to each invitee and transmits the selected content data stream 207 at the slowest common rate, such that all relevant players 607 simultaneously display the content data stream 207. That is, the previously described variable bit stream program applies to the transmission of the content data stream 207 to the invitees.

The active filtering of the interactive content distribution platform can be applied to any of a variety of content data streams 207. In an embodiment, the interactive content distribution platform employs a web crawler for available online radio stations, and presents a list of such available stations to the client computing device 209, wherein the active filtering is applied to the list so that the client computing device 209 or subaccounts of the client computing device 209 can access only selected stations from the list. In an embodiment, the interactive content distribution platform can employ web crawlers to monitor newly created websites and apply a rating to such newly created websites, and thus provide filtering for the content.

The interactive content distribution platform further provides synchronization between content data streams 207 not previously attainable. By encoding each content data stream 207, monitoring transmission rates and employing metadata, the interactive content distribution platform can synchronize content data streams 207, independent of whether the content data stream 207 is live or time shifted. Thus, the player 607 as authenticated upon access, and subsequent requests for access to content data streams 207 provides for viewing live streaming television (TV) broadcasts, where multiple content data streams 207 can be synchronized, for example, by shifting to a particular transmission rate, by metadata, by available transmission rates, etc., and the content of social networks can be integrated within the player 607.

Thus, as disclosed above, requests for access to a content data stream 207 are queried or authorized against a geolocation authorization database for each content data stream 207 and time block within a content data stream 207, wherein requests or existing content data streams 207 outside of an authorized geographical area for either the authorized instance of the player 607 or the client computing device 209 of the account owner, are blocked or disconnected. It has been found satisfactory to query or authenticate with respect to geolocation in response to a request for access to a content data stream 207 and at periodic intervals during transmission of the content data stream 207. The periodic interval can be predetermined intervals, for example, 5 minutes, 15 minutes, 30 minutes, or hour based intervals. The predetermined intervals can be of the order of a minute or less. With respect to the iPhone®, geolocation data can be obtained from commercially available iPhone® location services.

Further, an instance of the player 607 is identified uniquely only while participating in a session using account credentials and the described temporary nonce tokens. Clone devices are inhibited by the required download of verified software, that is, the player 607, upon access in combination with the account credentials upon access. Simultaneous connections and hence simultaneous access to content data streams 207 are disallowed at access to the content data stream 207 and authorization. As each access is subject to device and software authorization, previously authorized devices can be prevented from access. Thus, a computing device 209 or an instance of the player 607 is treated as non-trusted and is validated or authenticated upon each request for access to a content data stream 207. Updates for the player 607 are pushed to the client computing device 209 or provided upon download or installation of the player 607 from the application server 205, for example, the HTML media server at the head end 206 upon access.

The interactive content distribution platform also provides for interactivity by use of a reverse green screen. The image capture device 210 exemplarily illustrated in FIG. 2 associated with an authenticated account can be used to map an unoccupied room. That is, the image capture device 210 or a camera captures the image and transmits or accomplishes the data to the application server 205 at the player level. The application server 205 maps the pixel representation of the room. The user then enters the room and the image capture device 210 captures an image of the user and again captures an image of the room. However, the application server 205 or the player 607 removes the previously mapped background, thereby providing a digital representation of the user. The interactive content distribution platform can locate or dispose the digital representation of the user against any desired background layer such as a gaming environment or a learning environment. The interactive content distribution platform can thus register user movements without requiring manipulation of an input device by the user.

In an embodiment, the interactive content distribution platform employed for generating retail revenues has the following specifications:

| | |
|---|---|
| Stream Content | |
| Codec | AVC H.264 |
| Resolution | HD1080p |
| Container | RTMPE/HTTP (iPhone) |
| Encryption | AES (Adobe ® RTMPE Implementation) |
| Authentication | Client token (two levels) |
| Authorization | Both request and delivery |
| DVR | |
| Encryption | AES (Adobe ® RTMPE Implementation) |
| Storage | Head end and CDN |
| Caching | CDN (up to 7 days - as determined by |
| | licensed content) |
| Downloadable content | |
| Encryption | AES (Adobe ® Flash ® media rights |
| | management Implementation) |
| Codec | AVC H.264 |
| Resolution | HD 1080p |
| Container | Mp4/flv |
| DRM | HTML Media Rights Management |
| | Server with Adobe ® AIR ® |
| | application |
| Delivery | |
| CDN | Edgecast/Influxis or custom |
| Storage | Head end |
| Caching | Head end and CDN (On demand) |
| Client computing devices | |
| Supported OS | WindowsXP, Windows7, Windows8-Vista- |
| | Apple OS 10.4-Droid |
| Adobe | HTML Player 10 |
| iPhone | iPhone OS 3 |
| Server Specifications | |
| OS | Red Hat Enterprise 5 |
| Databases | postgreSQL 8 |
| Firewalls and Intrusion | |
| Detection | |
| Firewalls | Juniper Networks, IP firewall |
| Intrusion Detection | Snort |
| Encoding and Transcoding | |
| Hardware | Digital Rapids |
| Software | Digital Rapids Stream, FFMPEG, Transcode, |
| | and HTML Media Server |

In an embodiment, the interactive content distribution platform employs Adobe® Flash® 10 and can operate on commercially available personal computers (PCs) running Windows® XP, Windows® 7 or Windows® 8, Windows® Vista®, Droid as well as Mac brand computers running OSX 10.5 or higher; and for the iPhone® running 3G, 3GS and iPod® touch OS 3.1. For the PC and Mac computers, a satisfactory codec/bit rate and resolution has been found to be H.264-AAC 138k-720P or H.264-AAC 1184k-720P or H.264-MP30528k-360×240. For the iPhone®, a satisfactory codec/bit rate and resolution has been found to be H.264-AAC 364k-360×240. Encryption can be via Adobe® Flash® 10 with Adobe® RTMPE advanced encryption standard (AES) and for the iPhone® AES 128 bit using 16 octet keys. The encryption keys are managed by the delivery platforms: for the PC Adobe® RTMPE/FMIS/Adobe® Flash Access® 2.0 of Adobe Systems Incorporated; the Mac Apple HTTP Live Streaming/QuickTime streaming server and for the iPhone OS 3.1. Further, the interactive content distribution platform is configured so that asset management includes structured metadata with each live content data stream 207 or a VOD/electronic sell through (EST) asset. In response to each request for access, the metadata determines how the asset, for example, the content data stream 207 is used. In another embodiment, the interactive content distribution platform employs HTML5 for operation on multiple computing devices 209.

All metadata management and storage is performed by one or more databases within a private network, such as a virtual private database (VPD), such that the user does not have access to any metadata. Upon receipt, the authenticated player 607 decrypts the content data stream 207 with the Flash® ActionScript® virtual machine (AVM), and in the iPhone®, the content data stream 207 is decrypted with the QuickTime® library. The secrets, for example, keys, keys derivatives, etc., are managed by the respective platform, for example, Adobe® Flex Builder or QuickTime®, wherein authorization is managed using the temporary nonce, which are discarded once used.

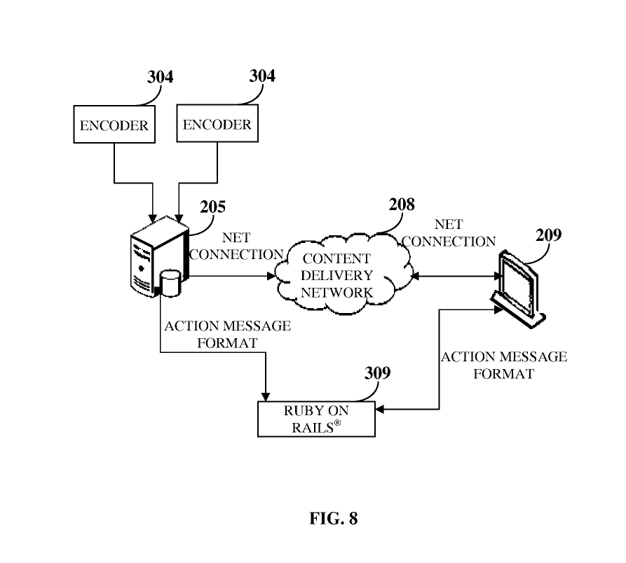

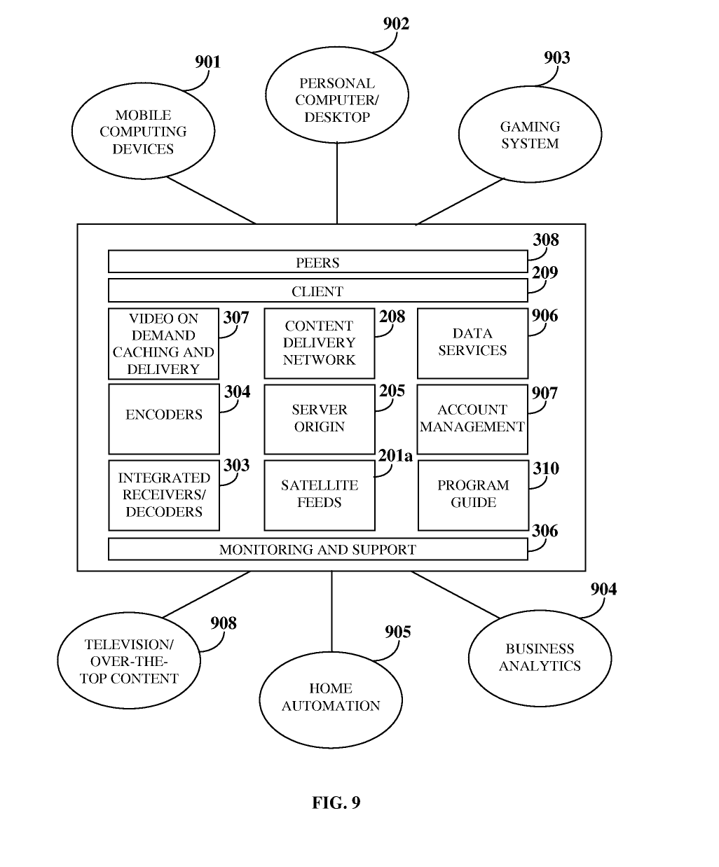

FIG. 9 exemplarily illustrates a schematic diagram showing components and features associated with the interactive content distribution platform. Multiple users using client computing devices 209, for example, mobile computing devices 901, a personal computer or a desktop 902, a gaming system 903, etc., can access the interactive content distribution platform. The interactive content distribution platform supports business analytics 904, home automation 905, and television (TV) and over the top content 908. Multiple peer computing devices 308 access the interactive content distribution platform through the client computing device 209, for example, using the real time media flow protocol (RTMFP). The interactive content distribution platform provides multiple features, for example, video on demand (VOD) caching and delivery 307, data services 906, account management 907, a program guide 310, etc., via the content delivery network (CDN) 208. The content data streams 207 are delivered to the users by the interactive content distribution platform via the application server 205, for example, the HTML media server. In an embodiment, the interactive content distribution platform receives the content data streams 207 in the form of satellite feeds 201a from the satellite receiver array 201 exemplarily illustrated in FIGS. 2-3. The satellite feeds 201a received from the satellite receiver array 201 are decoded using integrated receivers/decoders (IRDs) 303. The decoded content data streams 207 are transmitted to the encoders 304 to be converted to a common data format. Furthermore, the interactive content distribution platform comprises the monitoring and support component 306 for ensuring simultaneous distribution and display of the content data streams 207 of multiple content formats to the client computing devices 209 via the CDN 208.

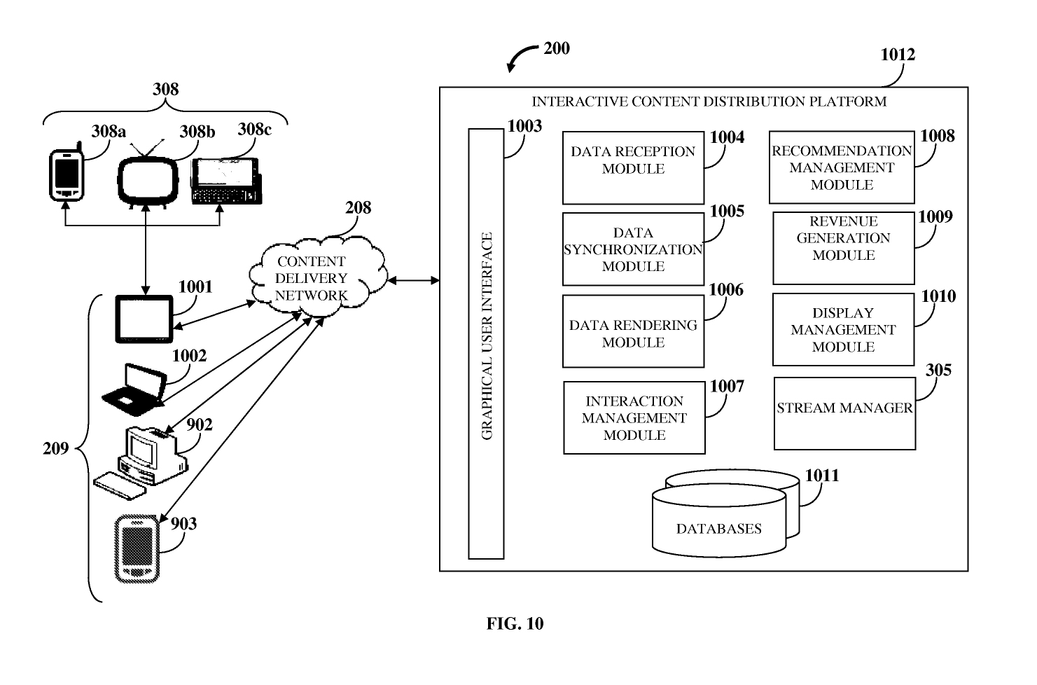

FIG. 10 exemplarily illustrates a computer implemented system 200 for simultaneously distributing multiple content data streams 207 exemplarily illustrated in FIGS. 2-3, of multiple content formats to one or more computing devices 209. The computer implemented system 200 disclosed herein comprises an interactive content distribution platform 1012 configured to provide a graphical user interface (GUI) 1003 accessible by each of the computing devices 209 via a network, for example, the content delivery network 208. Peer computing devices 308, for example, a smart phone 308a, a television 308b, a personal digital assistant 308c, etc., access the content delivery network 208 and the interactive content distribution platform 1012 through the client computing devices 209. The interactive content distribution platform 1012 comprises a non-transitory computer readable storage medium and at least one processor communicatively coupled to the non-transitory computer readable storage medium. As used herein, the phrase “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium stores modules, for example, 305, 1004, 1005, 1006, 1007, 1008, 1009, 1010, etc., of the interactive content distribution platform 1012. The processor is configured to execute computer program instructions defined by the modules, for example, 305, 1004, 1005, 1006, 1007, 1008, 1009, 1010, etc., of the interactive content distribution platform 1012.

The interactive content distribution platform 1012 further comprises a data reception module 1004, a data synchronization module 1005, a data rendering module 1006, an interaction management module 1007, a recommendation management module 1008, a revenue generation module 1009, a display management module 1010, the stream manager 305, and one or more databases 1011. The databases 1011 store one or more of the content data streams 207 of the content formats, information associated with the content data streams 207, information associated with the content sources, information associated with multiple users, etc. The databases 1011 are accessible by the users and/or the content sources via a network. The databases 1011 refer to any storage area or medium that can be used for storing data and files. The databases 1011 comprise, for example, a structured query language (SQL) data store or a not only SQL (NoSQL) data store such as the Microsoft® SQL Server®, the Oracle® servers, the MySQL° database of MySQL AB Company, the MongoDB° of 10gen, Inc., the Neo4j graph database, the Cassandra database of the Apache Software Foundation, the HBase™ database of the Apache Software Foundation, etc. In an embodiment, the databases 1011 can also be locations on a file system. In another embodiment, the databases 1011 can be remotely accessed by the interactive content distribution platform 1012 via a network, for example, the internet. In another embodiment, the databases 1011 are configured as cloud based databases implemented in a cloud computing environment, where computing resources are delivered as a service over a network, for example, the internet.

Multiple users access the interactive content distribution platform 1012 using their respective computing devices 209, for example, desktops 902, laptops 1002, tablets 1001, gaming systems 903, etc., or through peer computing devices 308, for example, smart phones 308a, televisions (TVs) 308b, personal digital assistants 308c, etc., for simultaneously receiving the content data streams 207 of different content formats in multiple configurable windows on their respective display screens 209a exemplarily illustrated in FIG. 2, via the GUI 1003 of the interactive content distribution platform 1012. The computing devices 209 connect to the interactive content distribution platform 1012 via the content delivery network (CDN) 208. In an embodiment, peer computing devices 308, for example, a smart phone 308a, a television 308b, a personal digital assistant (PDA) 308c, etc., access the interactive content distribution platform 1012 via their connection to a client computing device 209, for example, desktops 902, laptops 1002, tablets 1001, gaming systems 903, etc., that is connected to the interactive content distribution platform 1012 via the CDN 208.

The data reception module 1004 receives user selections of the content data streams 207 and the content formats via the GUI 1003. The data reception module 1004 receives the user selections through one or more of multiple communication modes, for example, a voice mode, a video mode, a text mode, a multimedia mode, a telephonic mode, etc., and any combination thereof. The data reception module 1004 receives one or more of the content data streams 207 in one or more of the content formats from multiple content sources based on the received user selections. The data synchronization module 1005 synchronizes the received content data streams 207 by encoding the received content data streams 207 into a common data format and adjusting a transmission rate of the received content data streams 207. The data rendering module 1006 simultaneously transmits and displays the synchronized content data streams 207 in one or more configurable windows on a display screen 209a of each of the computing devices 209 at configurable time instances via the GUI 1003. In an embodiment, the synchronized content data streams 207 in each of the configurable windows are changeable based on the received user selections.

The interaction management module 1007 facilitates interactions and initiates transactions between the computing devices 209 during the simultaneous display of the synchronized content data streams 207 in the configurable windows on the display screen 209a of each of the computing devices 209 via the GUI 1003. In an embodiment, the interaction management module 1007 facilitates the interactions by automatically transmitting and displaying one or more notifications and content in the configurable windows on the display screen 209a of each of other computing devices 209 of one or more users who are viewing the synchronized content data streams 207 on the other computing devices 209 via the GUI 1003. In an embodiment, the interaction management module 1007 facilitates the interactions by automatically transmitting and displaying one or more advertisements being viewed by one of multiple users to the configurable windows on the display screen 209a of each of the other users who are viewing the synchronized content data streams 207 on the other computing devices 209 via the GUI 1003. In an embodiment, the interaction management module 1007 manages user actions, for example, creating, modifying, deleting, storing, etc., performed on the synchronized content data streams 207.

The recommendation management module 1008 generates recommendations on themes and genres associated with the content data streams 207 based on the received user selections of one of multiple users, and transmits the generated recommendations to the other users via the content delivery network (CDN) 208, during the simultaneous display of the synchronized content data streams 207. The display management module 1010 configures one or more digital media parameters for incorporating one or more media effects in the displayed content data streams 207 in the configurable windows based on user preferences received via the GUI 1003.

In an embodiment, the revenue generation module 1009 generates revenue by enabling one or more content sources, for example, global cable providers, satellite distributors, telecommunication companies, and other content providers to white label the interactive content distribution platform 1012 in their name for simultaneously transmitting and displaying the synchronized content data streams 207 to one or more subscriber computing devices 209. The stream manager 305 monitors and controls traffic of the synchronized content data streams 207 between the computing devices 209 during the simultaneous transmission and display of the synchronized content data streams 207 in the configurable windows.

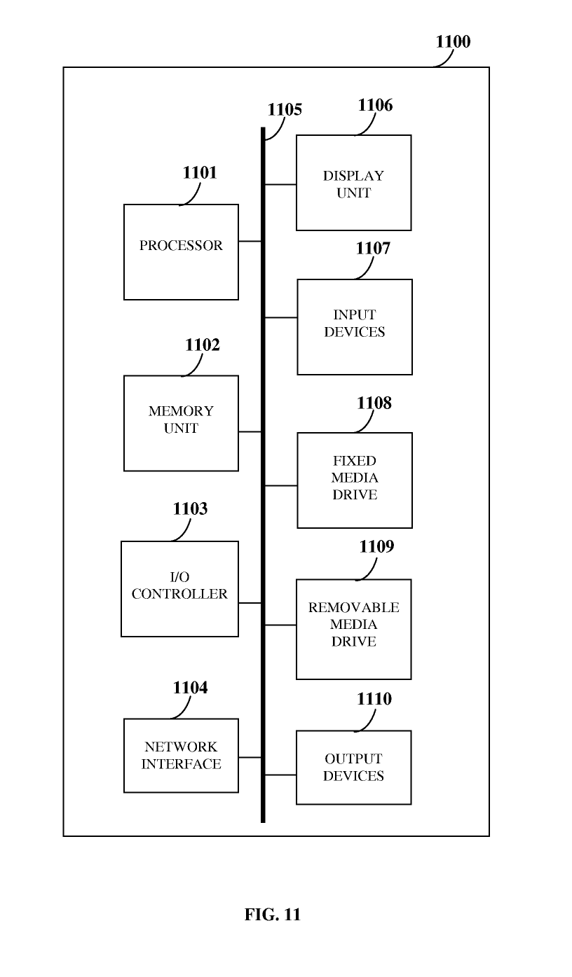

FIG. 11 exemplarily illustrates the architecture of a computer system 1100 employed by the interactive content distribution platform 1012 exemplarily illustrated in FIG. 10, for simultaneously distributing multiple content data streams 207 of multiple content formats to one or more computing devices 209 exemplarily illustrated in FIGS. 2-3 and FIGS. 8-10. The interactive content distribution platform 1012 of the computer implemented system 200 exemplarily illustrated in FIG. 10 employs the architecture of the computer system 1100 exemplarily illustrated in FIG. 11. The computer system 1100 is programmable using a high level computer programming language. The computer system 1100 may be implemented using programmed and purposeful hardware. The interactive content distribution platform 1012 communicates with the computing devices 209 of each of the users, for example, internet users, cable subscribers, social networking website users, television channel subscribers, etc., registered with the interactive content distribution platform 1012 via the content delivery network (CDN) 208, for example, a short range network or a long range network.

The computer system 1100 comprises, for example, a processor 1101, a non-transitory computer readable storage medium such as a memory unit 1102 for storing programs and data, an input/output (I/O) controller 1103, a network interface 1104, a data bus 1105, a display unit 1106, input devices 1107, a fixed media drive 1108, a removable media drive 1109 for receiving removable media, output devices 1110, etc. The processor 1101 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1101 may also be implemented as a processor set comprising, for example, a general purpose microprocessor and a math or graphics co-processor. The processor 1101 is selected, for example, from the Intel® processors such as the Itanium® microprocessor or the Pentium® processors, Advanced Micro Devices)(AMD° processors such as the Athlon® processor, UltraSPARC® processors, microSPARC® processors, Hp® processors, International Business Machines (IBM®) processors such as the PowerPC® microprocessor, the MIPS° reduced instruction set computer (RISC) processor of MIPS Technologies, Inc., RISC based computer processors of ARM Holdings, Motorola® processors, Qualcomm® processors, etc. The interactive content distribution platform 1012 disclosed herein is not limited to a computer system 1100 employing a processor 1101. The computer system 1100 may also employ a controller or a microcontroller. The processor 1101 executes the modules, for example, 305, 1004, 1005, 1006, 1007, 1008, 1009, 1010, etc., of the interactive content distribution platform 1012.

The memory unit 1102 is used for storing programs, applications, and data. For example, the data reception module 1004, the data synchronization module 1005, the data rendering module 1006, the interaction management module 1007, the recommendation management module 1008, the revenue generation module 1009, the display management module 1010, and the stream manager 305 of the interactive content distribution platform 1012 are stored in the memory unit 1102 of the computer system 1100. The memory unit 1102 is, for example, a random access memory (RAM) or another type of dynamic storage device that stores information and instructions for execution by the processor 1101. The memory unit 1102 also stores temporary variables and other intermediate information used during execution of the instructions by the processor 1101. The computer system 1100 further comprises a read only memory (ROM) or another type of static storage device that stores static information and instructions for the processor 1101. The I/O controller 1103 controls input actions and output actions performed by the interactive content distribution platform 1012.

The network interface 1104 enables connection of the computer system 1100 to the content delivery network 208. For example, the interactive content distribution platform 1012 connects to the content delivery network 208 via the network interface 1104. In an embodiment, the network interface 1104 is provided as an interface card also referred to as a line card. The network interface 1104 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 1105 permits communications between the modules, for example, 305, 1003, 1004, 1005, 1006, 1007, 1008, 1009, 1010, etc., of the interactive content distribution platform 1012.

The display unit 1106, via the graphical user interface (GUI) 1003, displays information, display interfaces, user interface elements such as text fields, checkboxes, text boxes, windows, etc., for allowing the users, for example, internet users, cable subscribers, social networking website users, television channel subscribers, etc., to enter a choice of a content data stream 207, a theme, or a genre for the content data stream 207, for viewing the content data stream 207. The display unit 1106 comprises, for example, a liquid crystal display, a plasma display, an organic light emitting diode (OLED) based display, etc. The input devices 1107 are used for inputting data associated with the content data streams 207 into the computer system 1100. The internet users, the cable subscribers, the social networking website users, the television channel subscribers, etc., use input devices of their computing devices 209 to provide inputs to the interactive content distribution platform 1012. For example, a user may enter a name of a content data stream 207 such as a movie using the input devices 1107. The input devices 1107 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 1100. The programs are loaded onto the fixed media drive 1108 and into the memory unit 1102 of the computer system 1100 via the removable media drive 1109. In an embodiment, the computer applications and programs may be loaded directly via the content delivery network 208. Computer applications and programs are executed by double clicking a related icon displayed on the display unit 1106 using one of the input devices 1107. The output devices 1110 output the results of operations performed by the interactive content distribution platform 1012. For example, the interactive content distribution platform 1012 displays one or more content data streams 207 in one or more configurable windows to users using the output devices 1110.

The processor 1101 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. The computer system 1100 employs the operating system for performing multiple tasks. The operating system is responsible for management and coordination of activities and sharing of resources of the computer system 1100. The operating system further manages security of the computer system 1100, peripheral devices connected to the computer system 1100, and network connections. The operating system employed on the computer system 1100 recognizes, for example, inputs provided by the users, the content sources, etc., using one of the input devices 1107, the output display, files, and directories stored locally on the fixed media drive 1108, for example, a hard drive. The operating system on the computer system 1100 executes different programs using the processor 1101. The processor 1101 and the operating system together define a computer platform for which application programs in high level programming languages are written.

The processor 1101 of the computer system 1100 employed by the interactive content distribution platform 1012 retrieves instructions defined by the data reception module 1004, the data synchronization module 1005, the data rendering module 1006, the interaction management module 1007, the recommendation management module 1008, the revenue generation module 1009, the display management module 1010, the stream manager 305, etc., of the interactive content distribution platform 1012 for performing respective functions disclosed in the detailed description of FIG. 10. The processor 1101 retrieves instructions for executing the modules, for example, 305, 1004, 1005, 1006, 1007, 1008, 1009, 1010, etc., of the interactive content distribution platform 1012 from the memory unit 1102. A program counter determines the location of the instructions in the memory unit 1102. The program counter stores a number that identifies the current position in the program of each of the modules, for example, 305, 1004, 1005, 1006, 1007, 1008, 1009, 1010, etc., of the interactive content distribution platform 1012. The instructions fetched by the processor 1101 from the memory unit 1102 after being processed are decoded. The instructions are stored in an instruction register in the processor 1101. After processing and decoding, the processor 1101 executes the instructions, thereby performing one or more processes defined by those instructions.

At the time of execution, the instructions stored in the instruction register are examined to determine the operations to be performed. The processor 1101 then performs the specified operations. The operations comprise arithmetic operations and logic operations. The operating system performs multiple routines for performing a number of tasks required to assign the input devices 1107, the output devices 1110, and memory for execution of the modules, for example, 305, 1004, 1005, 1006, 1007, 1008, 1009, 1010, etc., of the interactive content distribution platform 1012. The tasks performed by the operating system comprise, for example, assigning memory to the modules, for example, 305, 1004, 1005, 1006, 1007, 1008, 1009, 1010, etc., of the interactive content distribution platform 1012, and to data used by the interactive content distribution platform 1012, moving data between the memory unit 1102 and disk units, and handling input/output operations. The operating system performs the tasks on request by the operations and after performing the tasks, the operating system transfers the execution control back to the processor 1101. The processor 1101 continues the execution to obtain one or more outputs. The outputs of the execution of the modules, for example, 305, 1004, 1005, 1006, 1007, 1008, 1009, 1010, etc., of the interactive content distribution platform 1012 are displayed on the display unit 1106.

For purposes of illustration, the detailed description refers to the interactive content distribution platform 1012 being run locally on the computer system 1100; however the scope of the computer implemented method and system 200 disclosed herein is not limited to the interactive content distribution platform 1012 being run locally on the computer system 1100 via the operating system and the processor 1101, but may be extended to run remotely over the content delivery network (CDN) 208, for example, by employing a web browser and a remote server, a mobile phone, or other electronic devices. One or more portions of the computer system 1100 may be distributed across one or more computer systems (not shown) coupled to the CDN 208.

Disclosed herein is also a computer program product comprising a non-transitory computer readable storage medium that stores computer program codes comprising instructions executable by at least one processor 1101 for simultaneously distributing multiple content data streams 207 of multiple content formats to one or more computing devices 209. The computer program product comprises a first computer program code for receiving user selections of multiple content data streams 207 and multiple content formats for the content data streams 207 via the graphical user interface (GUI) 1003; a second computer program code for receiving one or more of the content data streams 207 in one or more of the content formats from multiple content sources based on the received user selections; a third computer program code for synchronizing the received content data streams 207 by encoding the received content data streams 207 into a common data format and adjusting a transmission rate of the received content data streams 207; a fourth computer program code for simultaneously transmitting and displaying the synchronized content data streams 207 in one or more configurable windows on a display screen 209a exemplarily illustrated in FIG. 2, of each of the computing devices 209 at configurable time instances via the GUI 1003; and a fifth computer program code for facilitating interactions and initiating transactions between the computing devices 209 during the simultaneous display of the synchronized content data streams 207 in the configurable windows on the display screen 209a of each of the computing devices 209 via the GUI 1003. The computer program product disclosed herein further comprises one or more additional computer program codes for performing additional steps that may be required and contemplated for simultaneously distributing multiple content data streams 207 of multiple content formats to one or more computing devices 209. In an embodiment, a single piece of computer program code comprising computer executable instructions performs one or more steps of the computer implemented method disclosed herein for simultaneously distributing multiple content data streams 207 of multiple content formats to one or more computing devices 209.

The computer program codes comprising computer executable instructions are embodied on the non-transitory computer readable storage medium. The processor 1101 of the computer system 1100 retrieves these computer executable instructions and executes them. When the computer executable instructions are executed by the processor 1101, the computer executable instructions cause the processor 1101 to perform the steps of the computer implemented method for simultaneously distributing multiple content data streams 207 of multiple content formats to one or more computing devices 209.

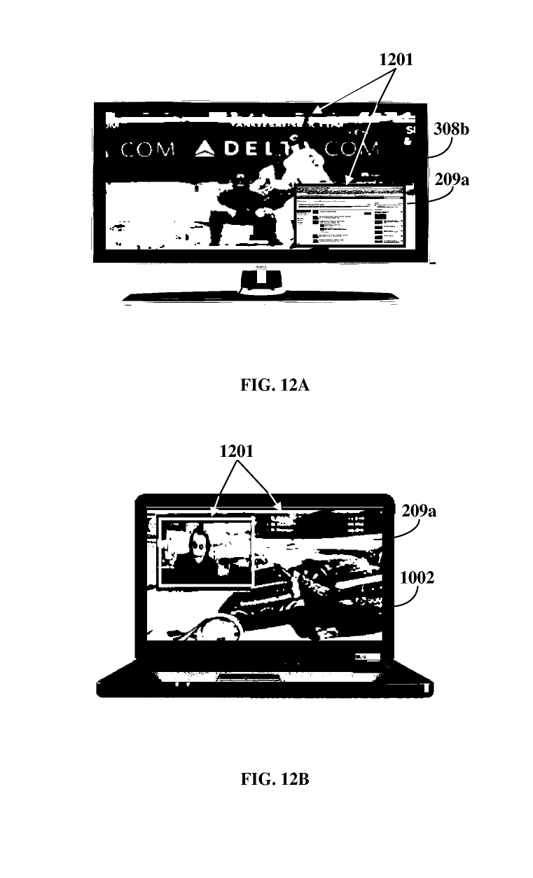

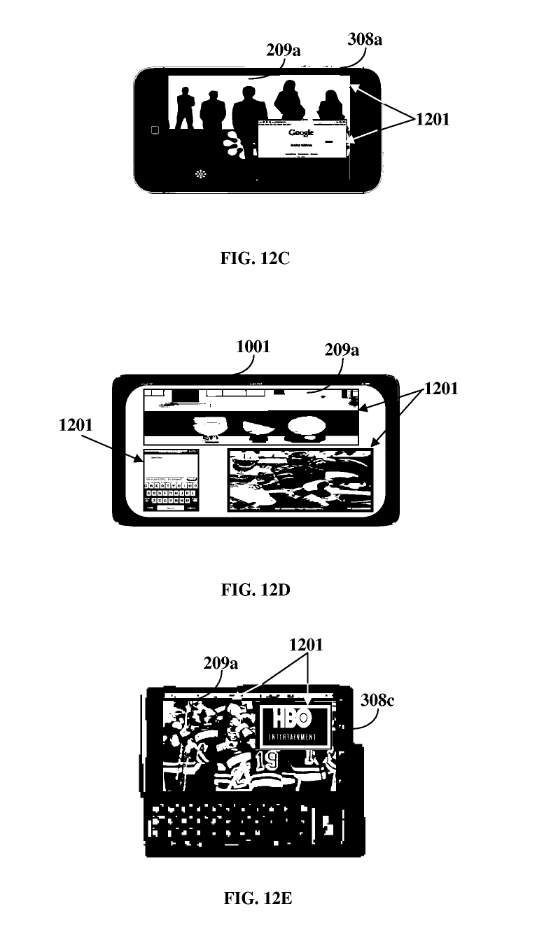

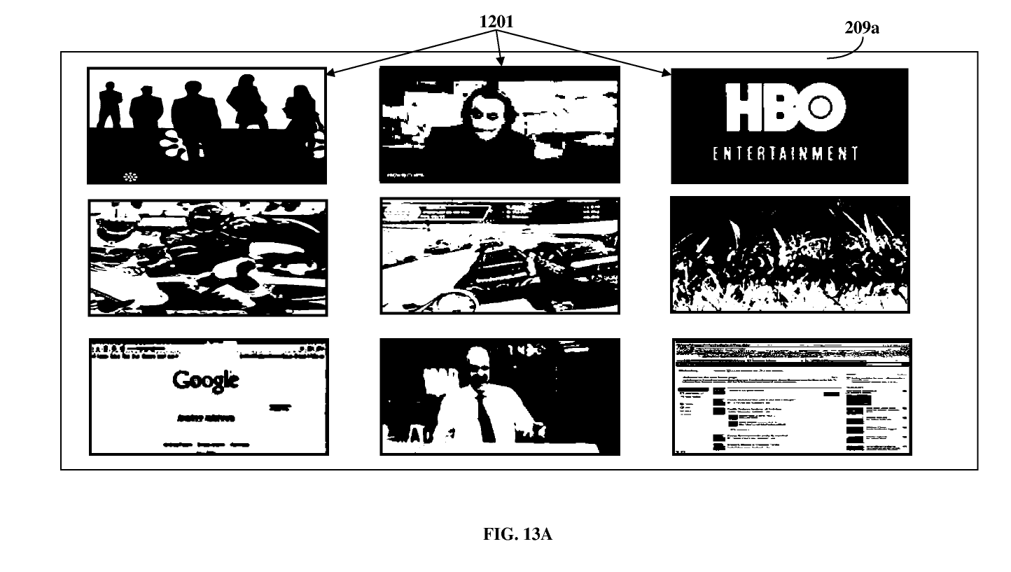

FIGS. 12A-12E exemplarily illustrate display screens 209a of multiple types of computing devices, for example, 308a, 308b, 308c, 1001, and 1002, displaying synchronized content data streams 207 exemplarily illustrated in FIG. 2-3, in multiple configurable windows 1201. Multiple users may access the interactive content distribution platform 1012 exemplarily illustrated in FIG. 10, using any network enabled or internet enabled computing device 209, for example, laptops 1002, tablets 1001, smart phones 308a, televisions (TVs) 308b, personal digital assistants 308c, etc., for simultaneously receiving multiple content data streams 207 of multiple content formats in configurable windows 1201 on their respective display screens 209a via the graphical user interface (GUI) 1003 of the interactive content distribution platform 1012 exemplarily illustrated in FIG. 10.

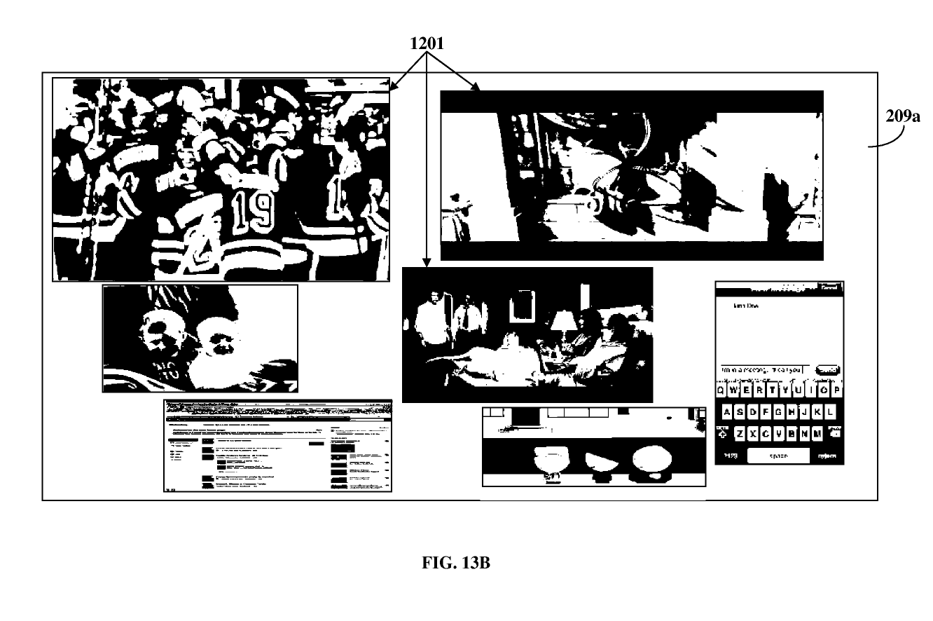

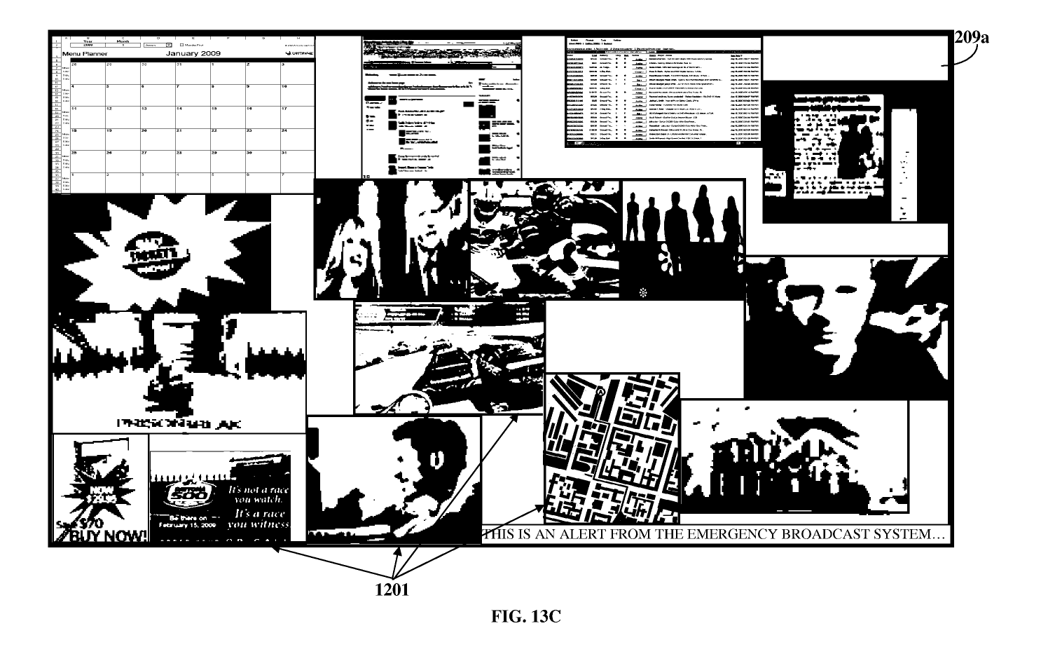

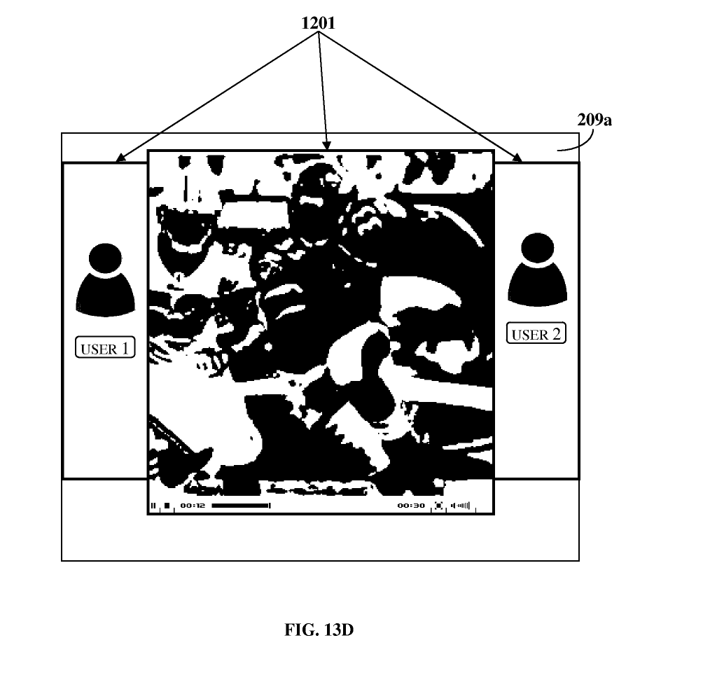

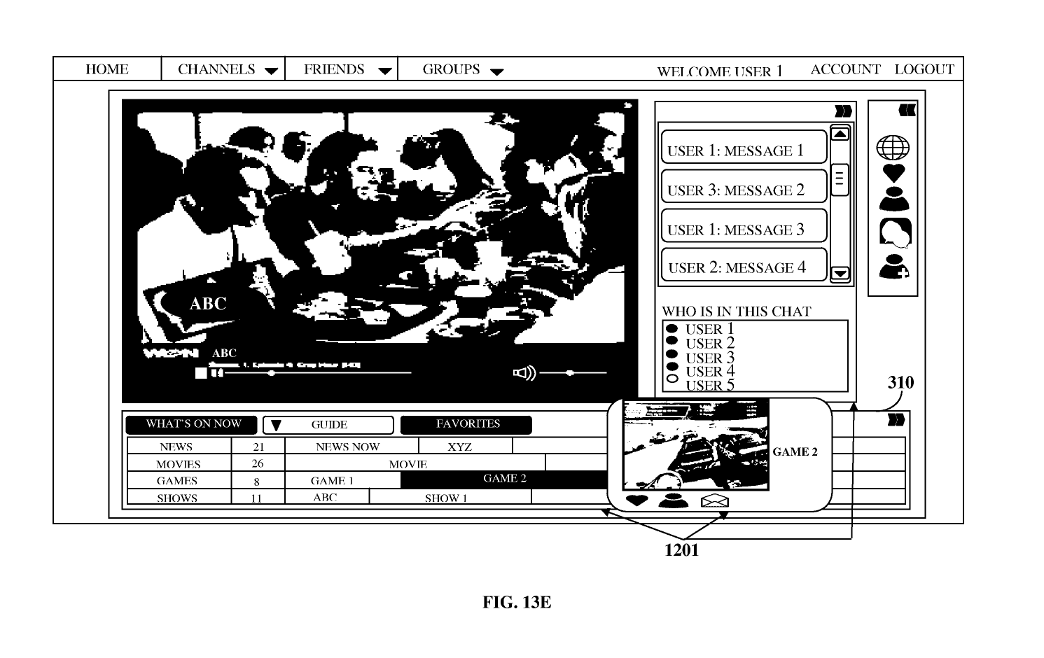

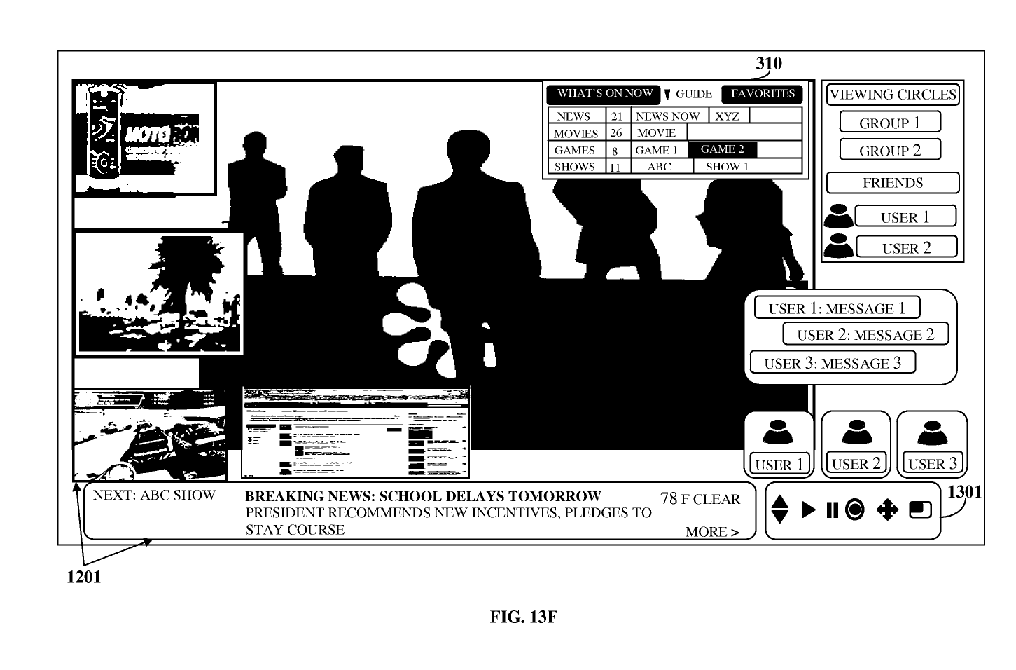

FIGS. 13A-13F exemplarily illustrate screenshots showing a simultaneous display of multiple synchronized content data streams 207 exemplarily illustrated in FIGS. 2-3, in multiple configurable windows 1201 on a display screen 209a of a computing device 209 via the graphical user interface (GUI) 1003 of the interactive content distribution platform 1012 exemplarily illustrated in FIG. 10. The interactive content distribution platform 1012 simultaneously distributes and displays multiple synchronized content data streams 207 in multiple configurable windows 1201 on the display screen 209a of the computing device 209 of a user. The interactive content distribution platform 1012 provides multitasking features that can be performed on any network enabled or internet enabled computing device 209. For example, the user may watch one or more movies, watch a sports game, browse a search engine, watch the news, visit a social networking website, etc., simultaneously through the configurable windows 1201 on the display screen 209a of the user's computing device 209. In another example, the user can simultaneously view live television (TV) shows, watch any combination of three live cable shows, two video on demand (VOD) programs, live chat with four or more friends, view three websites of news, sports, and health, watch Hulu® of Hulu, LLC, YouTube® of Google, Inc., or Netflix® of Netflix, Inc., text, send electronic mail (email), blog or customize their preferences in any combination they like. With simultaneous multi-live streaming of cable programming, the interactive content distribution platform 1012 allows the user to perform video chats and access, for example, up to 30 simultaneous content data streams 207 on one video display screen 209a. FIG. 13A exemplarily illustrates a screenshot showing a simultaneous display of multiple synchronized content data streams 207, for example, a television (TV) show, a sports game, a web browser, a movie, a video game, a chat show, a movie channel, a cartoon show, a social networking website, etc., in separate configurable windows 1201 on the display screen 209a of the user's computing device 209, for example, a TV. In an embodiment, the interactive content distribution platform 1012 presets a default configuration for the configurable windows 1201, where each of the configurable windows 1201 are of the same dimensions and equidistant from each other. In another embodiment, the interactive content distribution platform 1012 displays each of the configurable windows 1201 with differently shapes and sizes, as exemplarily illustrated in FIGS. 13B-13C. In this embodiment, the interactive content distribution platform 1012 enables the user using his/her respective computing device 209 to modify the dimensions or placement of the configurable windows 1201 via the GUI 1003 of the interactive content distribution platform 1012, for example, by clicking, dragging, expanding, etc., the configurable windows 1201.

The interactive content distribution platform 1012 provides live high definition streaming, live cable, movies, any digital video or data, with enhanced user functionality, including simultaneous multiple picture-in-picture (PIP), and moveable, expandable, shrinkable, floating, interchangeable and/or shape changeable configurable windows 1201 on one website 401 exemplarily illustrated in FIG. 4, with diverse multitasking features. The interactive content distribution platform 1012 further enables simultaneous multiple live personal or group chatting and conferencing, texting, blogging, emailing, social networking, gaming, web surfing, video on demand (VOD), etc., and provides privacy of sharing any digital content data stream 207 and digital video recorder (DVR) functionality to any broadband enabled computing device 209. The computer implemented method and system 200 exemplarily illustrated in FIGS. 2-3 and FIG. 10, disclosed herein enhances the viewing experience as the user or groups of users are able to watch and interact simultaneously, for example, with up to 30 video or content data streams 207. As long as the computing device 209 has access to a network such as the internet, the interactive content distribution platform 1012 provides the user with an optimized and convenient digital experience at his/her fingertips.

The users of the interactive content distribution platform 1012 can watch live network, cable, satellite programming, etc., online from the computing devices 209, for example, smart phones, high definition televisions (HDTVs), personal computers (PCs), other broadband enabled computing devices, etc., worldwide on one user friendly digital website 401. The users can enjoy live video chats while viewing video programs, accessing countless digital media formats, texting, emailing, accessing information and/or data, websites, or any form of digital video streaming content for entertainment, personalized communication features, business promotion, TV, web surfing, social networking, sharing their likes of live cable channels, VOD, YouTube®, Facebook®, Twitter®, advertisements, etc.

A user can video chat with two or more users while watching and commenting on a video as exemplarily illustrated in FIG. 13D. FIG. 13D exemplarily illustrates a screenshot showing a video chat session between a viewer and two users in separate configurable windows 1201 and a live telecast of a football game streaming from a television channel in another configurable window 1201 on a display screen 209a of the viewer. The viewer and the two users can video chat with each other while watching the football game on the display screen 209a of each of their computing devices 209. Similarly, a user can watch any content data stream 207 and simultaneously live chat with multiple persons simultaneously via the interactive content distribution platform 1012.

FIGS. 13E-13F exemplarily illustrate a screenshot showing a home page interface provided on the GUI 1003 of the interactive content distribution platform 1012, where the user can view multiple content data streams 207, for example, a show aired on a television channel, a product advertisement, a news telecast, etc., while simultaneously chatting with one or more users, playing a video game, accessing a personal electronic mail (email) account, etc. Furthermore, the interactive content distribution platform 1012 provides a program guide 310 to enable the user to navigate through all the content data streams 207 to which the user has access via his/her subscription with the interactive content distribution platform 1012. FIG. 13E also exemplarily illustrates a chat interface where multiple users can chat with each other via the network of the interactive content distribution platform 1012. Moreover, the interactive content distribution platform 1012 provides an embedded remote control panel 1301 exemplarily illustrated in FIG. 13F on the GUI 1003. The embedded remote control panel 1301 allows the user to control multiple media effects associated with the display of the content data stream 207, for example, volume, picture resolution, play/stop/resume/pause functionality, etc., on the display screen 209a of the user's computing device 209.

The users can promote their businesses, perform live chatting, blogging, and sharing of a cornucopia of digital information by utilizing multiple floating, expandable, and/or shape changeable picture-in-picture display screens 209a viewed across one digital site simultaneously while socially interacting with other users. Any digital data/video stream may be imported into each and every moveable, expandable, shrinkable, floating, interchangeable and/or shape changeable configurable window 1201, with up to, for example, 30 simultaneous live, time-shifted, recorded, social live-chat, digital matrices at any moment. The interactive content distribution platform 1012 enables a user to watch one channel and add on as he/she chooses, for example, up to 30 independent moveable, expandable, shrinkable, floating, interchangeable and/or shape changeable configurable windows 1201.

The interactive content distribution platform 1012 provides a dynamic matrix of live streaming of all cable TV series or channels, VOD, subscription video on demand (SVOD), digital video recorder (DVR) content, etc., enables web surfing, provides access to every network or channel that has its own site on the web, for example, Hulu®, YouTube®, etc., provides access to news, sports, and videoconferencing, through a configurable window 1201, while allowing a user to simultaneously text, perform live video chatting personally with one friend or a family or large groups, email, blog, social network, game, etc. The interactive content distribution platform 1012 further provides, for example, social TV, an interactive living room facility, etc., and enables processing of micro-transactions, social networking, social live chatting with multiple users or watching of any other online video service, whether the online video service is free or subscription based, that can be viewed individually or by multiple users simultaneously on the moveable, expandable, shrinkable, floating, interchangeable and/or shape changeable configurable windows 1201 that can also comprise picture-in-picture configurable windows 1201, on one display screen 209a of any web-enabled broadband computing device 209.

The interactive content distribution platform 1012 provides superior HD 1080p viewing quality capability, whether viewing one video stream on the site or multiple video streams, for example, up to 30 video content data streams 207 simultaneously; provides an enhanced channel programming guide and facilitates navigation; provides multiple picture-in-picture live video chat with multiple friends, family, other users, etc.; provides advertisement supported, fee based, or hybrid VOD/SVOD, DVR functionality such as pause, rewind, fast forward, record, etc.; simultaneously transmits multiple language audio streams; provides multiple language support within the GUI 1003, enables simultaneous web surfing; allows feature customization by users; provides the ability to access any other online service in order to watch multiple services, series, movies, VOD, websites, live chats, blogs, news, or sports in an immersive social setting or in complete privacy; provides multiple moveable, expandable, shrinkable, floating, interchangeable and/or shape changeable configurable windows 1201 simultaneously, whether free or by subscription; facilitates social networking; provides simultaneous access to content information associated with a show, a movie, an actor, an actress, a performance history, personal performer facts, other related shows, producer, writer, theme, history of each, etc.; enables purchase of products; maintains user preferences; allows parental blocking by a channel and/or rating; allows creation of a social user list or buddy list of friends and family; allows creation of a social favorites list of channels and shows; facilitates searching or listing of TV series/channels and movie sites accessible via the configurable windows 1201; allows rating of shows, movies or any other video streams or content data streams 207; allows viewing of most watched programs, highest rated programs, etc.; provides news scroll options; enables augmented reality processing of the content data streams 207; implements mobile applications; enables video conferencing, implements geo-filtering, registers user preferences, for example, likes, dislikes, etc., associated with content data streams 207; automatically responds to questions/queries asked by the users via the graphical user interface (GUI) 1003, for example, via tags; allows voice chats, text chats, for example, instant messaging, social and private chats, etc.; facilitates users to access “most blogged programs”, audio blogs, read other bloggers' comments, etc.

Furthermore, the interactive content distribution platform 1012 provides white labeling or business to business (B2B) licensing of the interactive content distribution platform 1012 to one or more of the content sources, for example, cable providers, satellite distributors, telecommunication companies, content providers, etc., to generate multi-platform revenue streams as disclosed in the detailed description of FIG. 1. Moreover, the interactive content distribution platform 1012 provides other B2B resources, for example, metadata on numerous parameters, for example, demographics, regional, location, age, gender, preferences, favorites, likes, dislikes, etc., digital rights management, targeted and customized advertisements inserted in the content data streams 207, etc., incorporates impulse advertising to provide the users with a “buy now” option in the content data streams 207 or through commercial and/or overlay advertisements; incorporates program advertisement overlays, for example, video advertisement overlays 605 exemplarily illustrated in FIG. 6, provides customizable tracking of the streaming content data streams 207, provides subscription to the content data streams 207, provides video on demand, facilitates advertising, generates retail revenue from the streamed content data streams 207, etc.

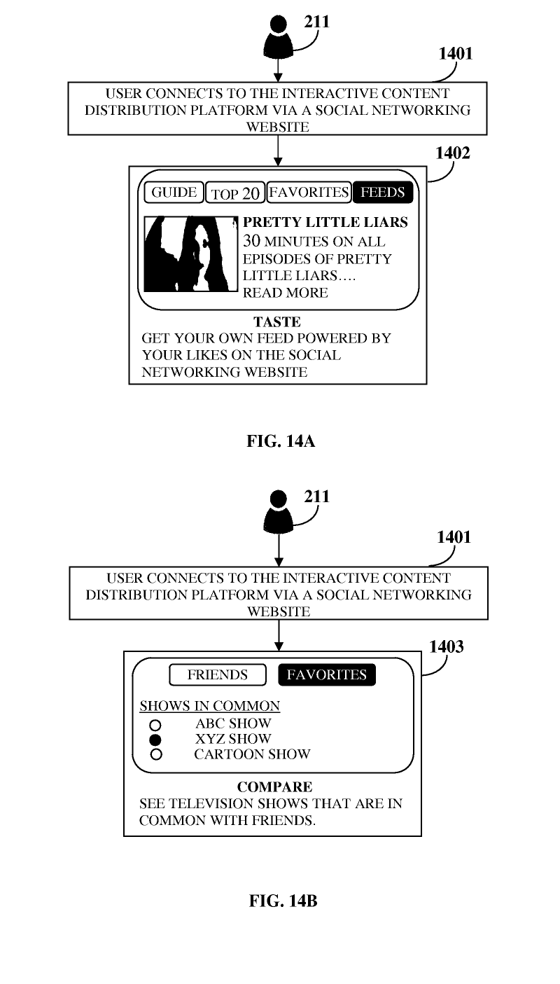

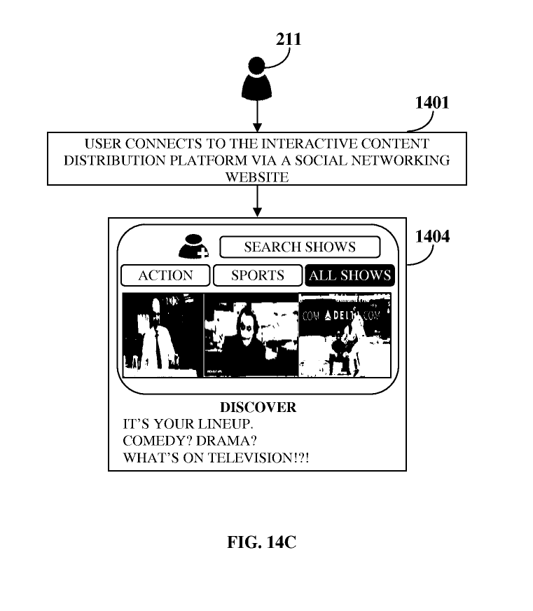

FIGS. 14A-14C exemplarily illustrate a flow diagram showing steps performed by a user 211 to access the interactive content distribution platform 1012 exemplarily illustrated in FIG. 10, via a social networking website, for example, Facebook®, and interact with other users subscribed to the interactive content distribution platform 1012. The user 211 connects 1401 to the interactive content distribution platform 1012 using his/her computing device 209 after logging in to the social networking website. FIG. 14A exemplarily illustrates a screenshot showing a feeds interface 1402 of the interactive content distribution platform 1012, where the user 211 can access information feeds associated with a content data stream 207 exemplarily illustrated in FIGS. 2-3, for example, a television show such as “Pretty little liars” liked by the user 211 on the social networking website. FIG. 14B exemplarily illustrates a screenshot showing a comparison interface 1403 of the interactive content distribution platform 1012, where the user 211 using the computing device 209 can compare his/her preferences for a content data stream 207 with other users' preferences updated on the social networking website, and access content data streams 207 that are in common with other users. FIG. 14C exemplarily illustrates a screenshot showing a search interface 1404 of the interactive content distribution platform 1012, where the user 211 using the computing device 209 can navigate through a list of content data streams 207 provided on the interactive content distribution platform 1012.

Consider an example where a user 211 using a computing device 209, for example, a laptop, wishes to access multiple internet enabled applications or content data streams 207 exemplarily illustrated in FIGS. 2-3 displayed on a single display screen 209a of the computing device 209 one at a time or simultaneously. The user 211 subscribes to and logs in to the interactive content distribution platform 1012 exemplarily illustrated in FIG. 10. The interactive content distribution platform 1012 prompts the user 211 with a list of the content data streams 207 supported by the interactive content distribution platform 1012. The user 211 selects one or more of the content data streams 207, for example, Linkedin®, Facebook®, YouTube®, text messaging, an employment portal, a sports channel, a news channel, etc., from the list and the interactive content distribution platform 1012 displays each of the selected content data streams 207 in a different configurable window 1201 on the display screen 209a. The user 211 can change TV channels or switch between different content data streams 207 using an interface element, for example, a button configured on the graphical user interface (GUI) 1003 of the interactive content distribution platform 1012. The user 211 can view the interface element while hovering over each of the configurable windows 1201. The user 211 can change the configuration settings, for example, display type, font size, image size, image quality, volume, etc., of the configurable window 1201 via a control guide provided on the GUI 1003 of the interactive content distribution platform 1012. The user 211 can move each of the configurable windows 1201 by clicking, dragging, or expanding the configurable windows 1201 via the GUI 1003 of the interactive content distribution platform 1012. Hence, the user 211 simultaneously accesses any digital matrix such as social networking, text messaging, live cable, live chats, internet, digital video recorder (DVR) movies, live TV shows, video games, etc., using his/her computing device 209.

It will be readily apparent that the various methods, algorithms, and computer programs disclosed herein may be implemented on computer readable media appropriately programmed for computing devices. As used herein, the phrase “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise Adobe® Flex Builder, C, C++, C#, Java®, JavaScript®, Fortran, Ruby, Pascal, Perl®, Python®, Visual Basic®, hypertext preprocessor (PHP), Microsoft®.NET, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises one or more computer program codes for implementing the processes of various embodiments.

Where databases are described, such as the databases 1011 comprising, for example, Rails® system associated databases, etc., it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for simultaneously distributing a plurality of content data streams of a plurality of content formats to one or more computing devices, comprising:
providing an interactive content distribution platform comprising at least one processor configured to simultaneously distribute said content data streams of said content formats to said one or more computing devices in real time, wherein said interactive content distribution platform is configured to provide a graphical user interface accessible by each of said one or more computing devices via a network;
receiving user selections of said content data streams and said content formats by said interactive content distribution platform via said graphical user interface;
receiving one or more of said content data streams in one or more of said content formats from a plurality of content sources by said interactive content distribution platform based on said received user selections;
synchronizing said received one or more of said content data streams by said interactive content distribution platform by encoding said received one or more of said content data streams into a common data format and adjusting a transmission rate of said received one or more of said content data streams by said interactive content distribution platform;
simultaneously transmitting and displaying said synchronized one or more of said content data streams in one or more configurable windows on a display screen of said each of said one or more computing devices at configurable time instances via said graphical user interface, by said interactive content distribution platform,
wherein said synchronized one or more of said content data streams in each of said one or more configurable windows are changeable based on said received user selections; and
facilitating interactions and initiating transactions between said one or more computing devices by said interactive content distribution platform during said simultaneous display of said synchronized one or more of said content data streams in said one or more configurable windows on said display screen of said each of said one or more computing devices via said graphical user interface.

2. The computer implemented method of claim 1, wherein said content data streams comprise live cable television content, live high definition streaming content, multimedia chat content, live multimedia chat content, video conferencing content, gaming content, web browsing content, video-on-demand content, home automation content, voice recognition content, social media networking content, live video content, canned video content, digital video recorder video content, user generated content, message content, electronic mail content, audio content, augmented reality content, three-dimensional media content, electronic commerce content, information, blog content, analytical information of viewed content, and multimedia content.

3. The computer implemented method of claim 1, wherein each of said received one or more of said content data streams is accessible via a link and is configured to serve as a gateway to another one or more of said content data streams.

4. The computer implemented method of claim 1, wherein said interactions facilitated by said interactive content distribution platform comprise one or more of:
automatically transmitting and displaying one or more notifications and content in said one or more configurable windows on said display screen of each of other computing devices of one or more users who are viewing said synchronized one or more of said content data streams on said other computing devices via said graphical user interface; and
automatically transmitting and displaying one or more advertisements being viewed by one of a plurality of users to said one or more configurable windows on said display screen of each of other of said users who are viewing said synchronized one or more of said content data streams on said other computing devices via said graphical user interface.

5. The computer implemented method of claim 1, wherein said user selections are received by said interactive content distribution platform through one or more of a plurality of communication modes, wherein said communication modes comprise a voice mode, a video mode, a text mode, a multimedia mode, a telephonic mode, and any combination thereof.

6. The computer implemented method of claim 1, further comprising managing user actions performed on said synchronized one or more of said content data streams by said interactive content distribution platform, wherein said user actions comprise creating, modifying, deleting, and storing said synchronized one or more of said content data streams.

7. The computer implemented method of claim 1, further comprising generating recommendations on themes and genres associated with said content data streams by said interactive content distribution platform based on said received user selections of one of a plurality of users, and transmitting said generated recommendations to other of said users via said network, during said simultaneous display of said synchronized one or more of said content data streams.

8. The computer implemented method of claim 1, further comprising generating revenue by enabling white labeling of said interactive content distribution platform by one or more of said content sources to allow said one or more of said content sources to simultaneously transmit and display said synchronized one or more of said content data streams to one or more subscriber computing devices.

9. The computer implemented method of claim 1, further comprising configuring one or more digital media parameters for incorporating one or more media effects in said displayed one or more of said content data streams in said one or more configurable windows by said interactive content distribution platform based on user preferences received via said graphical user interface.

10. The computer implemented method of claim 1, further comprising monitoring and controlling traffic of said synchronized one or more of said content data streams between said one or more computing devices during said simultaneous transmission and said display of said synchronized one or more of said content data streams in said one or more configurable windows.

11. A computer implemented system for simultaneously distributing a plurality of content data streams of a plurality of content formats to one or more computing devices, said computer implemented system comprising:
an interactive content distribution platform configured to provide a graphical user interface accessible by each of said one or more computing devices via a network, said interactive content distribution platform comprising:
a non-transitory computer readable storage medium configured to store modules of said interactive content distribution platform;
at least one processor communicatively coupled to said non-transitory computer readable storage medium, said at least one processor configured to execute computer program instructions defined by said modules of said interactive content distribution platform;
a data reception module configured to receive user selections of said content data streams and said content formats via said graphical user interface;
said data reception module further configured to receive one or more of said content data streams in one or more of said content formats from a plurality of content sources based on said received user selections;
a data synchronization module configured to synchronize said received one or more of said content data streams by encoding said received one or more of said content data streams into a common data format and adjusting a transmission rate of said received one or more of said content data streams;
a data rendering module configured to simultaneously transmit and display said synchronized one or more of said content data streams in one or more configurable windows on a display screen of said each of said one or more computing devices at configurable time instances via said graphical user interface, wherein said synchronized one or more of said content data streams in each of said one or more configurable windows are changeable based on said received user selections; and
an interaction management module configured to facilitate interactions and initiate transactions between said one or more computing devices during said simultaneous display of said synchronized one or more of said content data streams in said one or more configurable windows on said display screen of said each of said one or more computing devices via said graphical user interface.

12. The computer implemented system of claim 11, wherein each of said received one or more of said content data streams is accessible via a link and is configured to serve as a gateway to another one or more of said content data streams.

13. The computer implemented system of claim 11, wherein said interaction management module is configured to facilitate said interactions by one or more of:
automatically transmitting and displaying one or more notifications and content in said one or more configurable windows on said display screen of each of other computing devices of one or more users who are viewing said synchronized one or more of said content data streams on said other computing devices via said graphical user interface; and
automatically transmitting and displaying one or more advertisements being viewed by one of a plurality of users to said one or more configurable windows on said display screen of each of other of said users who are viewing said synchronized one or more of said content data streams on said other computing devices via said graphical user interface.

14. The computer implemented system of claim 11, wherein said data reception module is configured to receive said user selections through one or more of a plurality of communication modes, wherein said communication modes comprise a voice mode, a video mode, a text mode, a multimedia mode, a telephonic mode, and any combination thereof.

15. The computer implemented system of claim 11, wherein said interaction management module is further configured to manage user actions performed on said synchronized one or more of said content data streams, wherein said user actions comprise creating, modifying, deleting, and storing said synchronized one or more of said content data streams.

16. The computer implemented system of claim 11, wherein said interactive content distribution platform further comprises one or more databases configured to store one or more of said content data streams of said content formats, information associated with said content data streams, information associated with said content sources, and information associated with a plurality of users, wherein said databases are accessible by one or more of said users and said content sources via said network.

17. The computer implemented system of claim 11, wherein said interactive content distribution platform further comprises a recommendation management module configured to generate recommendations on themes and genres associated with said content data streams based on said received user selections of one of a plurality of users, and transmit said generated recommendations to other of said users via said network, during said simultaneous display of said synchronized one or more of said content data streams.

18. The computer implemented system of claim 11, wherein said interactive content distribution platform further comprises a revenue generation module configured to generate revenue by enabling white labeling of said interactive content distribution platform by one or more of said content sources to allow said one or more of said content sources to simultaneously transmit and display said synchronized one or more of said content data streams to one or more subscriber computing devices.

19. The computer implemented system of claim 11, wherein said interactive content distribution platform further comprises a display management module configured to configure one or more digital media parameters for incorporating one or more media effects in said displayed one or more of said content data streams in said one or more configurable windows based on user preferences received via said graphical user interface.

20. The computer implemented system of claim 11, wherein said interactive content distribution platform further comprises a stream manager configured to monitor and control traffic of said synchronized one or more of said content data streams between said one or more computing devices during said simultaneous transmission and said display of said synchronized one or more of said content data streams in said one or more configurable windows.

21. A computer program product comprising a non-transitory computer readable storage medium, said non-transitory computer readable storage medium storing computer program codes that comprise instructions executable by at least one processor, said computer program codes comprising:
a first computer program code for receiving user selections of a plurality of content data streams and a plurality of content formats for said content data streams via a graphical user interface;
a second computer program code for receiving one or more of said content data streams in one or more of said content formats from a plurality of content sources based on said received user selections;
a third computer program code for synchronizing said received one or more of said content data streams by encoding said received one or more of said content data streams into a common data format and adjusting a transmission rate of said received one or more of said content data streams;
a fourth computer program code for simultaneously transmitting and displaying said synchronized one or more of said content data streams in one or more configurable windows on a display screen of each of one or more computing devices at configurable time instances via said graphical user interface; and
a fifth computer program code for facilitating interactions and initiating transactions between said one or more computing devices during said simultaneous display of said synchronized one or more of said content data streams in said one or more configurable windows on said display screen of said each of said one or more computing devices via said graphical user interface.
